(19) United States
(12) Patent Application Publication
(10) Pub. No.: US 2026/0285184 A1
(43) Pub. Date: Sep. 24, 2026

(54) CHARGING/DISCHARGING MANAGEMENT SYSTEM, MANAGEMENT DEVICE, VEHICLE, AND CHARGING/DISCHARGING DEVICE

(71) Applicant: HONDA MOTOR CO., LTD., Tokyo (JP)

(72) Inventors: Takuya Tanaka, Tokyo (JP); Qianlong Wang, Tokyo (JP); Hakaru Sadano, Tokyo (JP)

(21) Appl. No.: 19/464,692

(22) Filed: Jan. 30, 2026

(30) Foreign Application Priority Data
Mar. 19, 2025 (JP) 2025-045625

(51) Int. Cl. B60L 53/62; B60L 53/16; B60L 53/66

(52) U.S. Cl. CPC B60L 53/62; B60L 53/16; B60L 53/66

(57) ABSTRACT

A charging/discharging management system according to an embodiment includes a vehicle including a power storage device, a charging/discharging device that performs charging or discharging for the vehicle, and a management device that manages charging/discharging, in which the vehicle has a first connection state acquirer that acquires first connection state information indicating a connection state between the charging/discharging device and the vehicle, and a first transmitter that transmits the first connection state information to the management device, the charging/discharging device has a second connection state acquirer that acquires second connection state information indicating a connection state between the charging/discharging device and the vehicle, and a second transmitter that transmits the second connection state information to the management device, and the charging/discharging management system has a determiner that determines a connection state between the charging/discharging device and the vehicle on the basis of the first connection state information and the second connection state information.

### CROSS-REFERENCE TO RELATED APPLICATIONS

This application is based on and claims the benefit of priority from Japanese Patent Application No. 2025-045625 filed in Japan on Mar. 19, 2025, the contents of which are hereby incorporated by reference in their entirety.

### BACKGROUND OF THE INVENTION

### Field of the Invention

The present invention relates to a charging/discharging management system, a management device, a vehicle, and a charging/discharging device.

### Description of Related Art

For example, JP 6142729 B1 discloses a vehicle charging system configured to be able to charge an in-vehicle power storage device from outside a vehicle via a charging connection portion. The charging system includes: a vehicle that is equipped with the power storage device and the charging connection portion for charging the power storage device; charging equipment that charges the power storage device via the charging connection portion of the vehicle; a connector that is detachably attachable to the charging connection portion and can be connected to the charging connection portion in a completely-fitted state in which charging is possible and a half-fitted state in which charging is not permitted; and a detector that is provided in the vehicle and detects whether a connection state of the connector is the completely-fitted state or the half-fitted state. The detector detects the connection state of the connector on the basis of a first signal and a second signal provided from the connector via the charging connection portion. The detector is, for example, a control device provided in the vehicle. The charging system includes, for example, a high level communication (HLC) unit (a unit for performing communication by superposing a high-frequency waveform on a control pilot signal) in each of the vehicle and the charging equipment. For example, the charging system superposes information indicating the connection state of the connector detected by the control device on the first signal (control pilot signal), and transmits the signal from the vehicle to the charging equipment.

### SUMMARY OF THE INVENTION

However, in a case where a dedicated circuit or device (for example, HLC unit or the like) for detailed detection of the connection state is provided on each of the vehicle side and the charging equipment side, the cost may be increased, or the convenience may be impaired due to low versatility.

Therefore, an object of the present invention is to suppress an increase in cost and a deterioration in convenience.

As means for solving the above-described problems, an aspect of the present invention has the following configuration.

(1) A charging/discharging management system according to an aspect of the present invention (for example, charging/discharging management system 100 according to the embodiment) is a charging/discharging management system including: a vehicle (for example, vehicle 101 according to the embodiment) including a power storage device (for example, power storage device 110 according to the embodiment); a charging/discharging device (for example, charging/discharging device 102 according to the embodiment) that performs charging or discharging for the vehicle; and a management device (for example, management device 103 according to the embodiment) that manages charging/discharging, in which the vehicle has a first connection state acquirer (for example, first connection state acquirer 111 according to the embodiment) that acquires first connection state information indicating a connection state between the charging/discharging device and the vehicle, and a first transmitter (for example, first transmitter 112 according to the embodiment) that transmits the first connection state information to the management device, the charging/discharging device has a second connection state acquirer (for example, second connection state acquirer 121 according to the embodiment) that acquires second connection state information indicating a connection state between the charging/discharging device and the vehicle, and a second transmitter (for example, second transmitter 122 according to the embodiment) that transmits the second connection state information to the management device, and the charging/discharging management system has a determiner (for example, determiner 105 according to the embodiment) that determines a connection state between the charging/discharging device and the vehicle on a basis of the first connection state information and the second connection state information.

(2) In the charging/discharging management system according to (1), at least one of the first connection state information and the second connection state information may indicate fitting or non-fitting as the connection state between the charging/discharging device and the vehicle.

(3) In the charging/discharging management system according to (1) or (2), when the first connection state information and the second connection state information indicate different states, the determiner may determine that the connection state between the charging/discharging device and the vehicle is an invalid state.

(4) In the charging/discharging management system according to any one of (1) to (3), the charging/discharging device may have a signal transmitter (for example, signal transmitter 123 according to the embodiment) that transmits a confirmation signal for confirming the connection state between the charging/discharging device and the vehicle to the vehicle, the vehicle may have a signal receiver (for example, signal receiver 113 according to the embodiment) that receives the confirmation signal, the charging/discharging management system may have a storage (for example, storage 106 according to the embodiment) that stores change information indicating a change in the first connection state information when the signal receiver receives the confirmation signal, and the determiner may determine the connection state between the charging/discharging device and the vehicle on a basis of the change information.

(5) In the charging/discharging management system according to (4), the determiner may determine the connection state between the charging/discharging device and the vehicle on a basis of a fact that the number of times the first connection state information changes is more than a predetermined number in a predetermined period.

(6) In the charging/discharging management system according to (4) or (5), the determiner may determine the connection state between the charging/discharging device and the vehicle on a basis of a charging/discharging instruction value received by the charging/discharging device in a predetermined period.

(7) In the charging/discharging management system according to (6), the determiner may determine the connection state between the charging/discharging device and the vehicle on a basis of whether the charging/discharging instruction value is 0 in the predetermined period.

(8) In the charging/discharging management system according to any one of (4) to (7), the signal transmitter may transmit the confirmation signal to the vehicle at a predetermined interval, and the determiner may determine the connection state between the charging/discharging device and the vehicle on a basis of the predetermined interval and an interval of the change information.

(9) In the charging/discharging management system according to any one of (1) to (3), the charging/discharging device may have a signal transmitter (for example, signal transmitter 123 according to the embodiment) that transmits a confirmation signal for confirming the connection state between the charging/discharging device and the vehicle to the vehicle, the vehicle may have a signal receiver (for example, signal receiver 113 according to the embodiment) that receives the confirmation signal, the charging/discharging management system may have a storage (for example, storage 106 according to the embodiment) that stores change information indicating a change in other state information different from the first connection state information when the signal receiver receives the confirmation signal, and the determiner may determine the connection state between the charging/discharging device and the vehicle on a basis of the change information.

(10) In the charging/discharging management system according to (9), the determiner may determine the connection state between the charging/discharging device and the vehicle on a basis of a fact that the number of times the other state information changes is more than a predetermined number in a predetermined period.

(11) In the charging/discharging management system according to (9) or (10), the determiner may determine the connection state between the charging/discharging device and the vehicle on a basis of a charging/discharging instruction value received by the charging/discharging device in a predetermined period.

(12) In the charging/discharging management system according to (11), the determiner may determine the connection state between the charging/discharging device and the vehicle on a basis of whether the charging/discharging instruction value is 0 in the predetermined period.

(13) In the charging/discharging management system according to any one of (9) to (12), the signal transmitter may transmit the confirmation signal to the vehicle at a predetermined interval, and the determiner may determine the connection state between the charging/discharging device and the vehicle on a basis of the predetermined interval and an interval of the change information.

(14) A charging/discharging management system according to an aspect of the present invention (for example, charging/discharging management system 100 according to the embodiment) is a charging/discharging management system including: a vehicle (for example, vehicle 101 according to the embodiment) including a power storage device (for example, power storage device 110 according to the embodiment); a charging/discharging device (for example, charging/discharging device 102 according to the embodiment) that performs charging or discharging for the vehicle; and a management device (for example, management device 103 according to the embodiment) that manages charging/discharging, in which the vehicle has a first connection state acquirer (for example, first connection state acquirer 111 according to the embodiment) that acquires first connection state information indicating a connection state between the charging/discharging device and the vehicle, and a first transmitter (for example, first transmitter 112 according to the embodiment) that transmits the first connection state information to the management device, the charging/discharging device has a second connection state acquirer (for example, second connection state acquirer 121 according to the embodiment) that acquires second connection state information indicating a connection state between the charging/discharging device and the vehicle, and a second transmitter (for example, second transmitter 122 according to the embodiment) that transmits the second connection state information to the management device, and the charging/discharging management system has a determiner (for example, determiner 105 according to the embodiment) that determines a connection state between the charging/discharging device and the vehicle on a basis of other state information different from the first connection state information.

(15) A management device according to an aspect of the present invention (for example, management device 103 according to the embodiment) is a management device that manages charging/discharging executed between a vehicle (for example, vehicle 101 according to the embodiment) including a power storage device (for example, power storage device 110 according to the embodiment) and a charging/discharging device (for example, charging/discharging device 102 according to the embodiment) that performs charging or discharging of the vehicle from an external power source, in which the management device has a determiner (for example, determiner 105 according to the embodiment) that determines a connection state between the charging/discharging device and the vehicle on a basis of first connection state information that is transmitted from a first transmitter (for example, first transmitter 112 according to the embodiment) of the vehicle and indicates a connection state between the charging/discharging device and the vehicle, and second connection state information that is transmitted from a second transmitter (for example, second transmitter 122 according to the embodiment) of the charging/discharging device and indicates a connection state between the charging/discharging device and the vehicle.

(16) In the management device according to (15), at least one of the first connection state information and the second connection state information may indicate fitting or non-fitting as the connection state between the charging/discharging device and the vehicle.

(17) In the management device according to (15) or (16), when the first connection state information and the second connection state information indicate different states, the determiner may determine that the connection state between the charging/discharging device and the vehicle is an invalid state.

(18) In the management device according to any one of (15) to (17), the charging/discharging device may have a signal transmitter (for example, signal transmitter 123 according to the embodiment) that transmits a confirmation signal for confirming the connection state between the charging/discharging device and the vehicle to the vehicle, the vehicle may have a signal receiver (for example, signal receiver 113 according to the embodiment) that receives the confirmation signal, the management device may have a storage (for example, storage 106 according to the embodiment) that stores change information indicating a change in the first connection state information when the signal receiver receives the confirmation signal, and the determiner may determine the connection state between the charging/discharging device and the vehicle on a basis of the change information.

(19) In the management device according to (18), the determiner may determine the connection state between the charging/discharging device and the vehicle on a basis of a fact that the number of times the first connection state information changes is more than a predetermined number in a predetermined period.

(20) In the management device according to (18) or (19), the determiner may determine the connection state between the charging/discharging device and the vehicle on a basis of a charging/discharging instruction value received by the charging/discharging device in a predetermined period.

(21) In the management device according to (20), the determiner may determine the connection state between the charging/discharging device and the vehicle on a basis of whether the charging/discharging instruction value is 0 in the predetermined period.

(22) In the management device according to any one of (18) to (21), the signal transmitter may transmit the confirmation signal to the vehicle at a predetermined interval, and the determiner may determine the connection state between the charging/discharging device and the vehicle on a basis of the predetermined interval and an interval of the change information.

(23) In the management device according to any one of (15) to (17), the charging/discharging device may have a signal transmitter (for example, signal transmitter 123 according to the embodiment) that transmits a confirmation signal for confirming the connection state between the charging/discharging device and the vehicle to the vehicle, the vehicle may have a signal receiver (for example, signal receiver 113 according to the embodiment) that receives the confirmation signal, the management device may have a storage (for example, storage 106 according to the embodiment) that stores change information indicating a change in other state information different from the first connection state information when the signal receiver receives the confirmation signal, and the determiner may determine the connection state between the charging/discharging device and the vehicle on a basis of the change information.

(24) In the management device according to (23), the determiner may determine the connection state between the charging/discharging device and the vehicle on a basis of a fact that the number of times the other state information changes is more than a predetermined number in a predetermined period.

(25) In the management device according to (23) or (24), the determiner may determine the connection state between the charging/discharging device and the vehicle on a basis of a charging/discharging instruction value received by the charging/discharging device in a predetermined period.

(26) In the management device according to (25), the determiner may determine the connection state between the charging/discharging device and the vehicle on a basis of whether the charging/discharging instruction value is 0 in the predetermined period.

(27) In the management device according to any one of (23) to (26), the signal transmitter may transmit the confirmation signal to the vehicle at a predetermined interval, and the determiner may determine the connection state between the charging/discharging device and the vehicle on a basis of the predetermined interval and an interval of the change information.

(28) A vehicle according to an aspect of the present invention (for example, vehicle 101 according to the embodiment) is a vehicle including: a power storage device (for example, power storage device 110 according to the embodiment), in which charging/discharging executed between the vehicle and a charging/discharging device (for example, charging/discharging device 102 according to the embodiment) that performs charging or discharging of the vehicle from an external power source is managed by a management device (for example, management device 103 according to the embodiment), the vehicle has a first connection state acquirer (for example, first connection state acquirer 111 according to the embodiment) that acquires first connection state information indicating a connection state between the charging/discharging device and the vehicle, and a first transmitter (for example, first transmitter 112 according to the embodiment) that transmits the first connection state information to the management device, the charging/discharging device has a second connection state acquirer (for example, second connection state acquirer 121 according to the embodiment) that acquires second connection state information indicating a connection state between the charging/discharging device and the vehicle, and a second transmitter (for example, second transmitter 122 according to the embodiment) that transmits the second connection state information to the management device, and the vehicle has a determiner (for example, determiner 105 according to the embodiment) that determines a connection state between the charging/discharging device and the vehicle on a basis of the first connection state information and the second connection state information.

(29) In the vehicle according to (28), at least one of the first connection state information and the second connection state information may indicate fitting or non-fitting as the connection state between the charging/discharging device and the vehicle.

(30) In the vehicle according to (28) or (29), when the first connection state information and the second connection state information indicate different states, the determiner may determine that the connection state between the charging/discharging device and the vehicle is an invalid state.

(31) In the vehicle according to any one of (28) to (30), the charging/discharging device may have a signal transmitter (for example, signal transmitter 123 according to the embodiment) that transmits a confirmation signal for confirming the connection state between the charging/discharging device and the vehicle to the vehicle, the vehicle may have a signal receiver (for example, signal receiver 113 according to the embodiment) that receives the confirmation signal, the vehicle may have a storage (for example, storage 106 according to the embodiment) that stores change information indicating a change in the first connection state information when the signal receiver receives the confirmation signal, and the determiner may determine the connection state between the charging/discharging device and the vehicle on a basis of the change information.

(32) In the vehicle according to (31), the determiner may determine the connection state between the charging/discharging device and the vehicle on a basis of a fact that the number of times the first connection state information changes is more than a predetermined number in a predetermined period.

(33) In the vehicle according to (31) or (32), the determiner may determine the connection state between the charging/discharging device and the vehicle on a basis of a charging/discharging instruction value received by the charging/discharging device in a predetermined period.

(34) In the vehicle according to (33), the determiner may determine the connection state between the charging/discharging device and the vehicle on a basis of whether the charging/discharging instruction value is 0 in the predetermined period.

(35) In the vehicle according to any one of (31) to (34), the signal transmitter may transmit the confirmation signal to the vehicle at a predetermined interval, and the determiner may determine the connection state between the charging/discharging device and the vehicle on a basis of the predetermined interval and an interval of the change information.

(36) In the vehicle according to any one of (28) to (30), the charging/discharging device may have a signal transmitter (for example, signal transmitter 123 according to the embodiment) that transmits a confirmation signal for confirming the connection state between the charging/discharging device and the vehicle to the vehicle, the vehicle may have a signal receiver (for example, signal receiver 113 according to the embodiment) that receives the confirmation signal, the vehicle may have a storage (for example, storage 106 according to the embodiment) that stores change information indicating a change in other state information different from the first connection state information when the signal receiver receives the confirmation signal, and the determiner may determine the connection state between the charging/discharging device and the vehicle on a basis of the change information.

(37) In the vehicle according to (36), the determiner may determine the connection state between the charging/discharging device and the vehicle on a basis of a fact that the number of times the other state information changes is more than a predetermined number in a predetermined period.

(38) In the vehicle according to (36) or (37), the determiner may determine the connection state between the charging/discharging device and the vehicle on a basis of a charging/discharging instruction value received by the charging/discharging device in a predetermined period.

(39) In the vehicle according to (38), the determiner may determine the connection state between the charging/discharging device and the vehicle on a basis of whether the charging/discharging instruction value is 0 in the predetermined period.

(40) In the vehicle according to any one of (36) to (39), the signal transmitter may transmit the confirmation signal to the vehicle at a predetermined interval, and the determiner may determine the connection state between the charging/discharging device and the vehicle on a basis of the predetermined interval and an interval of the change information.

(41) A charging/discharging device according to an aspect of the present invention (for example, charging/discharging device 102 according to the embodiment) is a charging/discharging device that performs charging or discharging for a vehicle (for example, vehicle 101 according to the embodiment) including a power storage device (for example, power storage device 110 according to the embodiment), in which charging/discharging executed between the vehicle and the charging/discharging device is managed by a management device (for example, management device 103 according to the embodiment), the vehicle has a first connection state acquirer (for example, first connection state acquirer 111 according to the embodiment) that acquires first connection state information indicating a connection state between the charging/discharging device and the vehicle, and a first transmitter (for example, first transmitter 112 according to the embodiment) that transmits the first connection state information to the management device, the charging/discharging device has a second connection state acquirer (for example, second connection state acquirer 121 according to the embodiment) that acquires second connection state information indicating a connection state between the charging/discharging device and the vehicle, and a second transmitter (for example, second transmitter 122 according to the embodiment) that transmits the second connection state information to the management device, and the charging/discharging device has a determiner (for example, determiner 105 according to the embodiment) that determines a connection state between the charging/discharging device and the vehicle on a basis of the first connection state information and the second connection state information.

(42) In the charging/discharging device according to (41), at least one of the first connection state information and the second connection state information may indicate fitting or non-fitting as the connection state between the charging/discharging device and the vehicle.

(43) In the charging/discharging device according to (41) or (42), when the first connection state information and the second connection state information indicate different states, the determiner may determine that the connection state between the charging/discharging device and the vehicle is an invalid state.

(44) In the charging/discharging device according to any one of (41) to (43), the charging/discharging device may have a signal transmitter (for example, signal transmitter 123 according to the embodiment) that transmits a confirmation signal for confirming the connection state between the charging/discharging device and the vehicle to the vehicle, the vehicle may have a signal receiver (for example, signal receiver 113 according to the embodiment) that receives the confirmation signal, the charging/discharging device may have a storage (for example, storage 106 according to the embodiment) that stores change information indicating a change in the first connection state information when the signal receiver receives the confirmation signal, and the determiner may determine the connection state between the charging/discharging device and the vehicle on a basis of the change information.

(45) In the charging/discharging device according to (44), the determiner may determine the connection state between the charging/discharging device and the vehicle on a basis of a fact that the number of times the first connection state information changes is more than a predetermined number in a predetermined period.

(46) In the charging/discharging device according to (44) or (45), the determiner may determine the connection state between the charging/discharging device and the vehicle on a basis of a charging/discharging instruction value received by the charging/discharging device in a predetermined period.

(47) In the charging/discharging device according to (46), the determiner may determine the connection state between the charging/discharging device and the vehicle on a basis of whether the charging/discharging instruction value is 0 in the predetermined period.

(48) In the charging/discharging device according to any one of (44) to (47), the signal transmitter may transmit the confirmation signal to the vehicle at a predetermined interval, and the determiner may determine the connection state between the charging/discharging device and the vehicle on a basis of the predetermined interval and an interval of the change information.

(49) In the charging/discharging device according to any one of (41) to (43), the charging/discharging device may have a signal transmitter (for example, signal transmitter 123 according to the embodiment) that transmits a confirmation signal for confirming the connection state between the charging/discharging device and the vehicle to the vehicle, the vehicle may have a signal receiver (for example, signal receiver 113 according to the embodiment) that receives the confirmation signal, the charging/discharging device may have a storage (for example, storage 106 according to the embodiment) that stores change information indicating a change in other state information different from the first connection state information when the signal receiver receives the confirmation signal, and the determiner may determine the connection state between the charging/discharging device and the vehicle on a basis of the change information.

(50) In the charging/discharging device according to (49), the determiner may determine the connection state between the charging/discharging device and the vehicle on a basis of a fact that the number of times the other state information changes is more than a predetermined number in a predetermined period.

(51) In the charging/discharging device according to (49) or (50), the determiner may determine the connection state between the charging/discharging device and the vehicle on a basis of a charging/discharging instruction value received by the charging/discharging device in a predetermined period.

(52) In the charging/discharging device according to (51), the determiner may determine the connection state between the charging/discharging device and the vehicle on a basis of whether the charging/discharging instruction value is 0 in the predetermined period.

(53) In the charging/discharging device according to any one of (49) to (52), the signal transmitter may transmit the confirmation signal to the vehicle at a predetermined interval, and the determiner may determine the connection state between the charging/discharging device and the vehicle on a basis of the predetermined interval and an interval of the change information.

According to the aspect of (1), the charging/discharging management system is a charging/discharging management system including a vehicle including a power storage device, a charging/discharging device that performs charging or discharging for the vehicle, and a management device that manages charging/discharging, in which the vehicle has a first connection state acquirer that acquires first connection state information indicating a connection state between the charging/discharging device and the vehicle, and a first transmitter that transmits the first connection state information to the management device, the charging/discharging device has a second connection state acquirer that acquires second connection state information indicating a connection state between the charging/discharging device and the vehicle, and a second transmitter that transmits the second connection state information to the management device, and the charging/discharging management system has a determiner that determines a connection state between the charging/discharging device and the vehicle on the basis of the first connection state information and the second connection state information, thereby achieving the following effects.

It is possible to determine the connection state between the charging/discharging device and the vehicle after collecting and comparing both the first connection state information and the second connection state information. Therefore, it is not necessary to provide a dedicated circuit or device that detects the connection state on the vehicle side and the charging/discharging device side. Therefore, it is possible to suppress an increase in cost and a deterioration in convenience.

According to the aspect of (2), at least one of the first connection state information and the second connection state information indicates fitting or non-fitting as the connection state between the charging/discharging device and the vehicle, thereby achieving the following effects.

It is possible to determine the connection state between the charging/discharging device and the vehicle after comparing the fitting or non-fitting indicated by at least one of the first connection state information and the second connection state information.

According to the aspect of (3), when the first connection state information and the second connection state information indicate different states, the determiner determines that the connection state between the charging/discharging device and the vehicle is an invalid state, thereby achieving the following effects.

In a case where the first connection state information and the second connection state information indicate different states, it can be determined that the connection state between the charging/discharging device and the vehicle is an invalid state. Therefore, it is possible to accurately detect an invalid state (for example, half-fitted state) without requiring a dedicated circuit or device on the vehicle side and the charging/discharging device side.

According to the aspect of (4), the charging/discharging device has a signal transmitter that transmits a confirmation signal for confirming the connection state between the charging/discharging device and the vehicle to the vehicle, the vehicle has a signal receiver that receives the confirmation signal, the charging/discharging management system has a storage that stores change information indicating a change in the first connection state information when the signal receiver receives the confirmation signal, and the determiner determines the connection state between the charging/discharging device and the vehicle on the basis of the change information, thereby achieving the following effects.

It is possible to determine the connection state between the charging/discharging device and the vehicle on the basis of the change information indicating a change in the first connection state information. For example, in a case where the first connection state information changes when the second connection state information indicates non-fitting, half-fitting can be more accurately detected.

According to the aspect of (5), the determiner determines the connection state between the charging/discharging device and the vehicle on the basis of the fact that the number of times the first connection state information changes is more than a predetermined number in a predetermined period, thereby achieving the following effects.

Redundancy can be provided, which can improve reliability and availability of the system.

According to the aspect of (6), the determiner determines the connection state between the charging/discharging device and the vehicle on the basis of a charging/discharging instruction value received by the charging/discharging device in a predetermined period, thereby achieving the following effects.

It is possible to determine the connection state between the charging/discharging device and the vehicle on the basis of a charging/discharging instruction value in a predetermined period. For example, it is possible to prevent erroneous notification in a case where the connection state information changes on the basis of the charging/discharging instruction value.

According to the aspect of (7), the determiner determines the connection state between the charging/discharging device and the vehicle on the basis of whether the charging/discharging instruction value is 0 in the predetermined period, thereby achieving the following effects.

It is possible to determine the connection state between the charging/discharging device and the vehicle on the basis of whether the charging/discharging instruction value is 0 in the predetermined period. For example, in a case where the connection state information changes even though there is no charging/discharging instruction, it can be determined that the connection state is invalid (for example, half-fitting), which is more accurate.

According to the aspect of (8), the signal transmitter transmits the confirmation signal to the vehicle at a predetermined interval, and the determiner determines the connection state between the charging/discharging device and the vehicle on the basis of the predetermined interval and an interval of the change information, thereby achieving the following effects.

It is possible to determine the connection state between the charging/discharging device and the vehicle on the basis of the predetermined interval and an interval of the change information. For example, it can be confirmed that the connection state information changes by the signal from the charging/discharging device, allowing for more accurate determination.

According to the aspect of (9), the charging/discharging device has a signal transmitter that transmits a confirmation signal for confirming the connection state between the charging/discharging device and the vehicle to the vehicle, the vehicle has a signal receiver that receives the confirmation signal, the charging/discharging management system has a storage that stores change information indicating a change in other state information different from the first connection state information when the signal receiver receives the confirmation signal, and the determiner determines the connection state between the charging/discharging device and the vehicle on the basis of the change information, thereby achieving the following effects.

It is possible to determine the connection state between the charging/discharging device and the vehicle on the basis of the change information indicating a change in other state information different from the first connection state information. For example, in a case where other state information (for example, activation state information of the vehicle) changes when the connection state between the charging/discharging device and the vehicle is non-fitting, half-fitting can be more accurately detected.

According to the aspect of (10), the determiner determines the connection state between the charging/discharging device and the vehicle on the basis of the fact that the number of times the other state information changes is more than a predetermined number in a predetermined period, thereby achieving the following effects.

Redundancy can be provided, which can improve reliability and availability of the system.

According to the aspect of (11), the determiner determines the connection state between the charging/discharging device and the vehicle on the basis of a charging/discharging instruction value received by the charging/discharging device in a predetermined period, thereby achieving the following effects.

It is possible to determine the connection state between the charging/discharging device and the vehicle on the basis of a charging/discharging instruction value in a predetermined period. For example, it is possible to prevent erroneous notification in a case where other state information changes on the basis of the charging/discharging instruction value.

According to the aspect of (12), the determiner determines the connection state between the charging/discharging device and the vehicle on the basis of whether the charging/discharging instruction value is 0 in the predetermined period, thereby achieving the following effects.

It is possible to determine the connection state between the charging/discharging device and the vehicle on the basis of whether the charging/discharging instruction value is 0 in the predetermined period. For example, in a case where other state information changes even though there is no charging/discharging instruction, it can be determined that the connection state is invalid (for example, half-fitting), which is more accurate.

According to the aspect of (13), the signal transmitter transmits the confirmation signal to the vehicle at a predetermined interval, and the determiner determines the connection state between the charging/discharging device and the vehicle on the basis of the predetermined interval and an interval of the change information, thereby achieving the following effects.

It is possible to determine the connection state between the charging/discharging device and the vehicle on the basis of the predetermined interval and an interval of the change information. For example, it can be confirmed that other state information changes by the signal from the charging/discharging device, allowing for more accurate determination.

According to the aspect of (14), the charging/discharging management system is a charging/discharging management system including a vehicle including a power storage device, a charging/discharging device that performs charging or discharging for the vehicle, and a management device that manages charging/discharging, in which the vehicle has a first connection state acquirer that acquires first connection state information indicating a connection state between the charging/discharging device and the vehicle, and a first transmitter that transmits the first connection state information to the management device, the charging/discharging device has a second connection state acquirer that acquires second connection state information indicating a connection state between the charging/discharging device and the vehicle, and a second transmitter that transmits the second connection state information to the management device, and the charging/discharging management system has a determiner that determines a connection state between the charging/discharging device and the vehicle on the basis of other state information different from the first connection state information, thereby achieving the following effects.

It is possible to determine the connection state between the charging/discharging device and the vehicle on the basis of other state information different from the first connection state information. Therefore, it is not necessary to provide a dedicated circuit or device that detects the connection state on the vehicle side and the charging/discharging device side. Therefore, it is possible to suppress an increase in cost and a deterioration in convenience.

According to the aspect of (15), the management device is a management device that manages charging/discharging executed between a vehicle including a power storage device and a charging/discharging device that performs charging or discharging of the vehicle from an external power source, in which the management device has a determiner that determines a connection state between the charging/discharging device and the vehicle on the basis of first connection state information that is transmitted from a first transmitter of the vehicle and indicates a connection state between the charging/discharging device and the vehicle, and second connection state information that is transmitted from a second transmitter of the charging/discharging device and indicates a connection state between the charging/discharging device and the vehicle, thereby achieving the following effects.

It is possible to determine the connection state between the charging/discharging device and the vehicle after collecting and comparing both the first connection state information and the second connection state information. Therefore, it is not necessary to provide a dedicated circuit or device that detects the connection state on the vehicle side and the charging/discharging device side. Therefore, it is possible to suppress an increase in cost and a deterioration in convenience.

According to the aspect of (16), at least one of the first connection state information and the second connection state information indicates fitting or non-fitting as the connection state between the charging/discharging device and the vehicle, thereby achieving the following effects.

It is possible to determine the connection state between the charging/discharging device and the vehicle after comparing the fitting or non-fitting indicated by at least one of the first connection state information and the second connection state information.

According to the aspect of (17), when the first connection state information and the second connection state information indicate different states, the determiner determines that the connection state between the charging/discharging device and the vehicle is an invalid state, thereby achieving the following effects.

In a case where the first connection state information and the second connection state information indicate different states, it can be determined that the connection state between the charging/discharging device and the vehicle is an invalid state. Therefore, it is possible to accurately detect an invalid state (for example, half-fitted state) without requiring a dedicated circuit or device on the vehicle side and the charging/discharging device side.

According to the aspect of (18), the charging/discharging device has a signal transmitter that transmits a confirmation signal for confirming the connection state between the charging/discharging device and the vehicle to the vehicle, the vehicle has a signal receiver that receives the confirmation signal, the management device has a storage that stores change information indicating a change in the first connection state information when the signal receiver receives the confirmation signal, and the determiner determines the connection state between the charging/discharging device and the vehicle on the basis of the change information, thereby achieving the following effects.

It is possible to determine the connection state between the charging/discharging device and the vehicle on the basis of the change information indicating a change in the first connection state information. For example, in a case where the first connection state information changes when the second connection state information indicates non-fitting, half-fitting can be more accurately detected.

According to the aspect of (19), the determiner determines the connection state between the charging/discharging device and the vehicle on the basis of the fact that the number of times the first connection state information changes is more than a predetermined number in a predetermined period, thereby achieving the following effects.

Redundancy can be provided, which can improve reliability and availability of the system.

According to the aspect of (20), the determiner determines the connection state between the charging/discharging device and the vehicle on the basis of a charging/discharging instruction value received by the charging/discharging device in a predetermined period, thereby achieving the following effects.

It is possible to determine the connection state between the charging/discharging device and the vehicle on the basis of a charging/discharging instruction value in a predetermined period. For example, it is possible to prevent erroneous notification in a case where the connection state information changes on the basis of the charging/discharging instruction value.

According to the aspect of (21), the determiner determines the connection state between the charging/discharging device and the vehicle on the basis of whether the charging/discharging instruction value is 0 in the predetermined period, thereby achieving the following effects.

It is possible to determine the connection state between the charging/discharging device and the vehicle on the basis of whether the charging/discharging instruction value is 0 in the predetermined period. For example, in a case where the connection state information changes even though there is no charging/discharging instruction, it can be determined that the connection state is invalid (for example, half-fitting), which is more accurate.

According to the aspect of (22), the signal transmitter transmits the confirmation signal to the vehicle at a predetermined interval, and the determiner determines the connection state between the charging/discharging device and the vehicle on the basis of the predetermined interval and an interval of the change information, thereby achieving the following effects.

It is possible to determine the connection state between the charging/discharging device and the vehicle on the basis of the predetermined interval and an interval of the change information. For example, it can be confirmed that the connection state information changes by the signal from the charging/discharging device, allowing for more accurate determination.

According to the aspect of (23), the charging/discharging device has a signal transmitter that transmits a confirmation signal for confirming the connection state between the charging/discharging device and the vehicle to the vehicle, the vehicle has a signal receiver that receives the confirmation signal, the management device has a storage that stores change information indicating a change in other state information different from the first connection state information when the signal receiver receives the confirmation signal, and the determiner determines the connection state between the charging/discharging device and the vehicle on the basis of the change information, thereby achieving the following effects.

It is possible to determine the connection state between the charging/discharging device and the vehicle on the basis of the change information indicating a change in other state information different from the first connection state information. For example, in a case where other state information (for example, activation state information of the vehicle) changes when the connection state between the charging/discharging device and the vehicle is non-fitting, half-fitting can be more accurately detected.

According to the aspect of (24), the determiner determines the connection state between the charging/discharging device and the vehicle on the basis of the fact that the number of times the other state information changes is more than a predetermined number in a predetermined period, thereby achieving the following effects.

Redundancy can be provided, which can improve reliability and availability of the system.

According to the aspect of (25), the determiner determines the connection state between the charging/discharging device and the vehicle on the basis of a charging/discharging instruction value received by the charging/discharging device in a predetermined period, thereby achieving the following effects.

It is possible to determine the connection state between the charging/discharging device and the vehicle on the basis of a charging/discharging instruction value in a predetermined period. For example, it is possible to prevent erroneous notification in a case where other state information changes on the basis of the charging/discharging instruction value.

According to the aspect of (26), the determiner determines the connection state between the charging/discharging device and the vehicle on the basis of whether the charging/discharging instruction value is 0 in the predetermined period, thereby achieving the following effects.

It is possible to determine the connection state between the charging/discharging device and the vehicle on the basis of whether the charging/discharging instruction value is 0 in the predetermined period. For example, in a case where other state information changes even though there is no charging/discharging instruction, it can be determined that the connection state is invalid (for example, half-fitting), which is more accurate.

According to the aspect of (27), the signal transmitter transmits the confirmation signal to the vehicle at a predetermined interval, and the determiner determines the connection state between the charging/discharging device and the vehicle on the basis of the predetermined interval and an interval of the change information, thereby achieving the following effects.

It is possible to determine the connection state between the charging/discharging device and the vehicle on the basis of the predetermined interval and an interval of the change information. For example, it can be confirmed that other state information changes by the signal from the charging/discharging device, allowing for more accurate determination.

According to the aspect of (28), the vehicle is a vehicle including a power storage device, in which charging/discharging executed between the vehicle and a charging/discharging device that performs charging or discharging of the vehicle from an external power source is managed by a management device, the vehicle has a first connection state acquirer that acquires first connection state information indicating a connection state between the charging/discharging device and the vehicle, and a first transmitter that transmits the first connection state information to the management device, the charging/discharging device has a second connection state acquirer that acquires second connection state information indicating a connection state between the charging/discharging device and the vehicle, and a second transmitter that transmits the second connection state information to the management device, and the vehicle has a determiner that determines a connection state between the charging/discharging device and the vehicle on the basis of the first connection state information and the second connection state information, thereby achieving the following effects.

It is possible to determine the connection state between the charging/discharging device and the vehicle after collecting and comparing both the first connection state information and the second connection state information. Therefore, it is not necessary to provide a dedicated circuit or device that detects the connection state on the vehicle side and the charging/discharging device side. Therefore, it is possible to suppress an increase in cost and a deterioration in convenience.

According to the aspect of (29), at least one of the first connection state information and the second connection state information indicates fitting or non-fitting as the connection state between the charging/discharging device and the vehicle, thereby achieving the following effects.

It is possible to determine the connection state between the charging/discharging device and the vehicle after comparing the fitting or non-fitting indicated by at least one of the first connection state information and the second connection state information.

According to the aspect of (30), when the first connection state information and the second connection state information indicate different states, the determiner determines that the connection state between the charging/discharging device and the vehicle is an invalid state, thereby achieving the following effects.

In a case where the first connection state information and the second connection state information indicate different states, it can be determined that the connection state between the charging/discharging device and the vehicle is an invalid state. Therefore, it is possible to accurately detect an invalid state (for example, half-fitted state) without requiring a dedicated circuit or device on the vehicle side and the charging/discharging device side.

According to the aspect of (31), the charging/discharging device has a signal transmitter that transmits a confirmation signal for confirming the connection state between the charging/discharging device and the vehicle to the vehicle, the vehicle has a signal receiver that receives the confirmation signal, the vehicle has a storage that stores change information indicating a change in the first connection state information when the signal receiver receives the confirmation signal, and the determiner determines the connection state between the charging/discharging device and the vehicle on the basis of the change information, thereby achieving the following effects.

It is possible to determine the connection state between the charging/discharging device and the vehicle on the basis of the change information indicating a change in the first connection state information. For example, in a case where the first connection state information changes when the second connection state information indicates non-fitting, half-fitting can be more accurately detected.

According to the aspect of (32), the determiner determines the connection state between the charging/discharging device and the vehicle on the basis of the fact that the number of times the first connection state information changes is more than a predetermined number in a predetermined period, thereby achieving the following effects.

Redundancy can be provided, which can improve reliability and availability of the system.

According to the aspect of (33), the determiner determines the connection state between the charging/discharging device and the vehicle on the basis of a charging/discharging instruction value received by the charging/discharging device in a predetermined period, thereby achieving the following effects.

It is possible to determine the connection state between the charging/discharging device and the vehicle on the basis of a charging/discharging instruction value in a predetermined period. For example, it is possible to prevent erroneous notification in a case where the connection state information changes on the basis of the charging/discharging instruction value.

According to the aspect of (34), the determiner determines the connection state between the charging/discharging device and the vehicle on the basis of whether the charging/discharging instruction value is 0 in the predetermined period, thereby achieving the following effects.

It is possible to determine the connection state between the charging/discharging device and the vehicle on the basis of whether the charging/discharging instruction value is 0 in the predetermined period. For example, in a case where the connection state information changes even though there is no charging/discharging instruction, it can be determined that the connection state is invalid (for example, half-fitting), which is more accurate.

According to the aspect of (35), the signal transmitter transmits the confirmation signal to the vehicle at a predetermined interval, and the determiner determines the connection state between the charging/discharging device and the vehicle on the basis of the predetermined interval and an interval of the change information, thereby achieving the following effects.

It is possible to determine the connection state between the charging/discharging device and the vehicle on the basis of the predetermined interval and an interval of the change information. For example, it can be confirmed that the connection state information changes by the signal from the charging/discharging device, allowing for more accurate determination.

According to the aspect of (36), the charging/discharging device has a signal transmitter that transmits a confirmation signal for confirming the connection state between the charging/discharging device and the vehicle to the vehicle, the vehicle has a signal receiver that receives the confirmation signal, the vehicle has a storage that stores change information indicating a change in other state information different from the first connection state information when the signal receiver receives the confirmation signal, and the determiner determines the connection state between the charging/discharging device and the vehicle on the basis of the change information, thereby achieving the following effects.

It is possible to determine the connection state between the charging/discharging device and the vehicle on the basis of the change information indicating a change in other state information different from the first connection state information. For example, in a case where other state information (for example, activation state information of the vehicle) changes when the connection state between the charging/discharging device and the vehicle is non-fitting, half-fitting can be more accurately detected.

According to the aspect of (37), the determiner determines the connection state between the charging/discharging device and the vehicle on the basis of the fact that the number of times the other state information changes is more than a predetermined number in a predetermined period, thereby achieving the following effects.

Redundancy can be provided, which can improve reliability and availability of the system.

According to the aspect of (38), the determiner determines the connection state between the charging/discharging device and the vehicle on the basis of a charging/discharging instruction value received by the charging/discharging device in a predetermined period, thereby achieving the following effects.

It is possible to determine the connection state between the charging/discharging device and the vehicle on the basis of a charging/discharging instruction value in a predetermined period. For example, it is possible to prevent erroneous notification in a case where other state information changes on the basis of the charging/discharging instruction value.

According to the aspect of (39), the determiner determines the connection state between the charging/discharging device and the vehicle on the basis of whether the charging/discharging instruction value is 0 in the predetermined period, thereby achieving the following effects.

It is possible to determine the connection state between the charging/discharging device and the vehicle on the basis of whether the charging/discharging instruction value is 0 in the predetermined period. For example, in a case where other state information changes even though there is no charging/discharging instruction, it can be determined that the connection state is invalid (for example, half-fitting), which is more accurate.

According to the aspect of (40), the signal transmitter transmits the confirmation signal to the vehicle at a predetermined interval, and the determiner determines the connection state between the charging/discharging device and the vehicle on the basis of the predetermined interval and an interval of the change information, thereby achieving the following effects.

It is possible to determine the connection state between the charging/discharging device and the vehicle on the basis of the predetermined interval and an interval of the change information. For example, it can be confirmed that other state information changes by the signal from the charging/discharging device, allowing for more accurate determination.

According to the aspect of (41), the charging/discharging device is a charging/discharging device that performs charging or discharging for a vehicle including a power storage device, in which charging/discharging executed between the vehicle and the charging/discharging device is managed by a management device, the vehicle has a first connection state acquirer that acquires first connection state information indicating a connection state between the charging/discharging device and the vehicle, and a first transmitter that transmits the first connection state information to the management device, the charging/discharging device has a second connection state acquirer that acquires second connection state information indicating a connection state between the charging/discharging device and the vehicle, and a second transmitter that transmits the second connection state information to the management device, and the charging/discharging device has a determiner that determines a connection state between the charging/discharging device and the vehicle on the basis of the first connection state information and the second connection state information, thereby achieving the following effects.

It is possible to determine the connection state between the charging/discharging device and the vehicle after collecting and comparing both the first connection state information and the second connection state information. Therefore, it is not necessary to provide a dedicated circuit or device that detects the connection state on the vehicle side and the charging/discharging device side. Therefore, it is possible to suppress an increase in cost and a deterioration in convenience.

According to the aspect of (42), at least one of the first connection state information and the second connection state information indicates fitting or non-fitting as the connection state between the charging/discharging device and the vehicle, thereby achieving the following effects.

It is possible to determine the connection state between the charging/discharging device and the vehicle after comparing the fitting or non-fitting indicated by at least one of the first connection state information and the second connection state information.

According to the aspect of (43), when the first connection state information and the second connection state information indicate different states, the determiner determines that the connection state between the charging/discharging device and the vehicle is an invalid state, thereby achieving the following effects.

In a case where the first connection state information and the second connection state information indicate different states, it can be determined that the connection state between the charging/discharging device and the vehicle is an invalid state. Therefore, it is possible to accurately detect an invalid state (for example, half-fitted state) without requiring a dedicated circuit or device on the vehicle side and the charging/discharging device side.

According to the aspect of (44), the charging/discharging device has a signal transmitter that transmits a confirmation signal for confirming the connection state between the charging/discharging device and the vehicle to the vehicle, the vehicle has a signal receiver that receives the confirmation signal, the charging/discharging device has a storage that stores change information indicating a change in the first connection state information when the signal receiver receives the confirmation signal, and the determiner determines the connection state between the charging/discharging device and the vehicle on the basis of the change information, thereby achieving the following effects.

It is possible to determine the connection state between the charging/discharging device and the vehicle on the basis of the change information indicating a change in the first connection state information. For example, in a case where the first connection state information changes when the second connection state information indicates non-fitting, half-fitting can be more accurately detected.

According to the aspect of (45), the determiner determines the connection state between the charging/discharging device and the vehicle on the basis of the fact that the number of times the first connection state information changes is more than a predetermined number in a predetermined period, thereby achieving the following effects.

Redundancy can be provided, which can improve reliability and availability of the system.

According to the aspect of (46), the determiner determines the connection state between the charging/discharging device and the vehicle on the basis of a charging/discharging instruction value received by the charging/discharging device in a predetermined period, thereby achieving the following effects.

It is possible to determine the connection state between the charging/discharging device and the vehicle on the basis of a charging/discharging instruction value in a predetermined period. For example, it is possible to prevent erroneous notification in a case where the connection state information changes on the basis of the charging/discharging instruction value.

According to the aspect of (47), the determiner determines the connection state between the charging/discharging device and the vehicle on the basis of whether the charging/discharging instruction value is 0 in the predetermined period, thereby achieving the following effects.

It is possible to determine the connection state between the charging/discharging device and the vehicle on the basis of whether the charging/discharging instruction value is 0 in the predetermined period. For example, in a case where the connection state information changes even though there is no charging/discharging instruction, it can be determined that the connection state is invalid (for example, half-fitting), which is more accurate.

According to the aspect of (48), the signal transmitter transmits the confirmation signal to the vehicle at a predetermined interval, and the determiner determines the connection state between the charging/discharging device and the vehicle on the basis of the predetermined interval and an interval of the change information, thereby achieving the following effects.

It is possible to determine the connection state between the charging/discharging device and the vehicle on the basis of the predetermined interval and an interval of the change information. For example, it can be confirmed that the connection state information changes by the signal from the charging/discharging device, allowing for more accurate determination.

According to the aspect of (49), the charging/discharging device has a signal transmitter that transmits a confirmation signal for confirming the connection state between the charging/discharging device and the vehicle to the vehicle, the vehicle has a signal receiver that receives the confirmation signal, the charging/discharging device has a storage that stores change information indicating a change in other state information different from the first connection state information when the signal receiver receives the confirmation signal, and the determiner determines the connection state between the charging/discharging device and the vehicle on the basis of the change information, thereby achieving the following effects.

It is possible to determine the connection state between the charging/discharging device and the vehicle on the basis of the change information indicating a change in other state information different from the first connection state information. For example, in a case where other state information (for example, activation state information of the vehicle) changes when the connection state between the charging/discharging device and the vehicle is non-fitting, half-fitting can be more accurately detected.

According to the aspect of (50), the determiner determines the connection state between the charging/discharging device and the vehicle on the basis of the fact that the number of times the other state information changes is more than a predetermined number in a predetermined period, thereby achieving the following effects.

Redundancy can be provided, which can improve reliability and availability of the system.

According to the aspect of (51), the determiner determines the connection state between the charging/discharging device and the vehicle on the basis of a charging/discharging instruction value received by the charging/discharging device in a predetermined period, thereby achieving the following effects.

It is possible to determine the connection state between the charging/discharging device and the vehicle on the basis of a charging/discharging instruction value in a predetermined period. For example, it is possible to prevent erroneous notification in a case where other state information changes on the basis of the charging/discharging instruction value.

According to the aspect of (52), the determiner determines the connection state between the charging/discharging device and the vehicle on the basis of whether the charging/discharging instruction value is 0 in the predetermined period, thereby achieving the following effects.

It is possible to determine the connection state between the charging/discharging device and the vehicle on the basis of whether the charging/discharging instruction value is 0 in the predetermined period. For example, in a case where other state information changes even though there is no charging/discharging instruction, it can be determined that the connection state is invalid (for example, half-fitting), which is more accurate.

According to the aspect of (53), the signal transmitter transmits the confirmation signal to the vehicle at a predetermined interval, and the determiner determines the connection state between the charging/discharging device and the vehicle on the basis of the predetermined interval and an interval of the change information, thereby achieving the following effects.

It is possible to determine the connection state between the charging/discharging device and the vehicle on the basis of the predetermined interval and an interval of the change information. For example, it can be confirmed that other state information changes by the signal from the charging/discharging device, allowing for more accurate determination.

### BRIEF DESCRIPTION OF THE DRAWINGS

FIG. 1 is a schematic diagram showing a configuration of a charging/discharging management system according to an embodiment;

FIG. 2 is a block diagram showing the configuration of the charging/discharging management system according to the embodiment;

FIG. 3 is a diagram showing configurations on a vehicle side and an EVSE side of the charging/discharging management system according to the embodiment;

FIG. 4 is a diagram for explaining a change in the fitted state when a charging/discharging device according to the embodiment is connected to a vehicle;

FIG. 5 is a diagram for explaining a change in the fitted state when the charging/discharging device according to the embodiment is removed from the vehicle;

FIG. 6 is a perspective view showing an example of a charging gun and an inlet according to the embodiment;

FIG. 7 is a perspective view including a cross section showing an example of a locking mechanism, the charging gun, and the inlet according to the embodiment;

FIG. 8 is a perspective view showing an example of a front portion of the vehicle according to the embodiment;

FIG. 9 is a top view showing an example of the inlet and an unlock switch according to the embodiment;

FIG. 10 is a diagram for explaining fitting flags of the vehicle and the charging/discharging device according to the embodiment;

FIG. 11 is a diagram for explaining a communication operation in a state where the charging/discharging device according to the embodiment is not connected to the vehicle;

FIG. 12 is a diagram for explaining a communication operation in a state where the charging/discharging device according to the embodiment is connected to the vehicle (fitted state);

FIG. 13 is a diagram for explaining a communication operation in a state where the charging/discharging device according to the embodiment is connected to the vehicle (half-fitted state);

FIG. 14 is a flowchart showing an example of a fitting alert system according to the embodiment;

FIG. 15 is a flowchart showing a first example of a fitting alert logic according to the embodiment;

FIG. 16 is a flowchart showing a second example of the fitting alert logic according to the embodiment;

FIG. 17 is a flowchart showing a third example of the fitting alert logic according to the embodiment;

FIG. 18 is a diagram showing an example of a temporal change in the activation voltage during normal fitting according to the embodiment;

FIG. 19 is a diagram showing an example of a temporal change in the activation voltage during half-fitting according to the embodiment;

FIG. 20 is a block diagram showing a configuration of a charging/discharging management system according to a second embodiment; and

FIG. 21 is a block diagram showing a configuration of a charging/discharging management system according to a third embodiment.

### DETAILED DESCRIPTION OF THE INVENTION

Hereinafter, embodiments of the present invention will be described with reference to the drawings. In the drawings used in the following description, the scale of each element is appropriately changed in order to make each element recognizable in size.

### <Charging/discharging Management System>

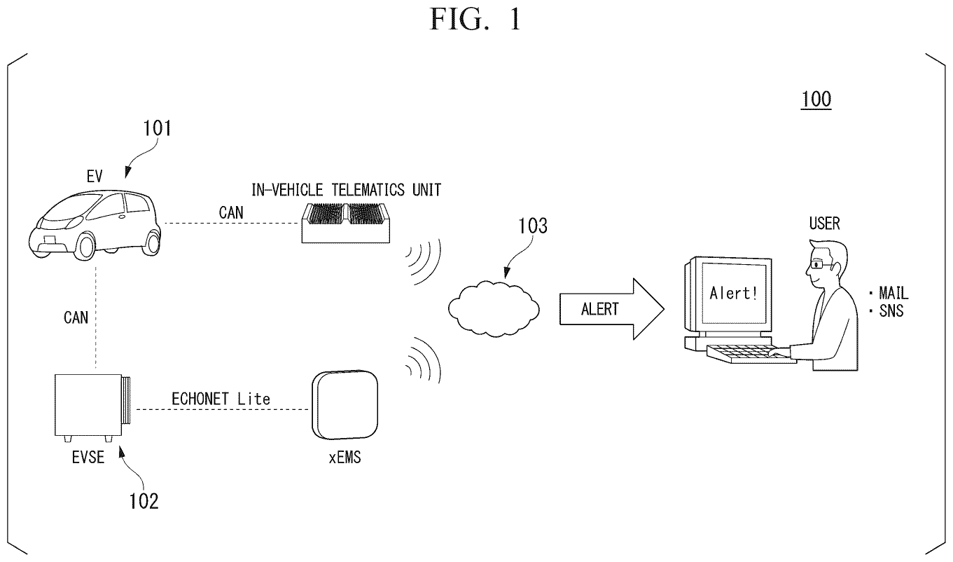

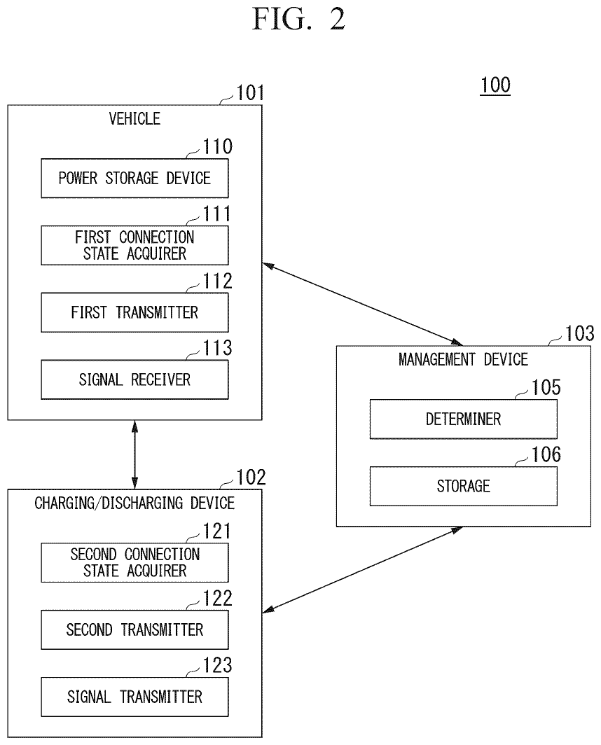

FIG. 1 is a schematic diagram showing a configuration of a charging/discharging management system 100 according to an embodiment. FIG. 2 is a block diagram showing the configuration of the charging/discharging management system 100 according to the embodiment.

Referring to FIGS. 1 and 2 together, the charging/discharging management system 100 includes a vehicle 101 including a power storage device 110, a charging/discharging device 102 that performs charging or discharging for the vehicle 101, and a management device 103 that manages charging/discharging. The vehicle 101, the charging/discharging device 102, and the management device 103 are communicable with each other through a multiplex communication line such as a controller area network (CAN) communication line, a serial communication line, a wireless communication network, or the like.

The vehicle 101 is, for example, an electric vehicle (EV). The vehicle 101 may be a vehicle such as an electric vehicle or a plug-in hybrid vehicle configured to be able to charge the in-vehicle power storage device 110 from the outside. The vehicle 101 has a first connection state acquirer 111 that acquires first connection state information indicating a connection state between the charging/discharging device 102 and the vehicle 101, and a first transmitter 112 that transmits the first connection state information to the management device 103. The first transmitter 112 is, for example, an in-vehicle telematics unit. The in-vehicle telematics unit is an in-vehicle telematics device that is mounted on the vehicle 101 and performs communication via a network. The EV is communicable with the in-vehicle telematics unit by CAN, for example.

The charging/discharging device 102 is, for example, electric vehicle supply equipment (EVSE). The EVSE is communicable with the EV by CAN, for example. The charging/discharging device 102 includes, for example, an energy management system (EMS). The EMS is communicable with the EVSE by ECHONET Lite (registered trademark), for example. The charging/discharging device 102 has a second connection state acquirer 121 that acquires second connection state information indicating a connection state between the charging/discharging device 102 and the vehicle 101, and a second transmitter 122 that transmits the second connection state information to the management device 103. The second transmitter 122 may be, for example, EVSE or an EMS.

At least one of the first connection state information and the second connection state information indicates fitting or non-fitting as the connection state between the charging/discharging device 102 and the vehicle 101. The first connection state information is, for example, a fitting flag (a flag indicating fitting or non-fitting) or the like held on the vehicle 101 side. The second connection state information is, for example, a fitting flag (a flag indicating fitting or non-fitting) or the like held on the EVSE side.

The charging/discharging management system 100 has a determiner 105 that determines a connection state between the charging/discharging device 102 and the vehicle 101 on the basis of the first connection state information and the second connection state information. In the present embodiment, the determiner 105 is provided in the management device 103. The management device 103 may function as, for example, a cloud server or a management server that communicates with the vehicle 101 and the charging/discharging device 102 via a network and transmits and receives various data. The network includes, for example, the Internet, a wide area network (WAN), a local area network (LAN), a phone line, a public line, a dedicated line, a provider device, a wireless base station, and the like.

The charging/discharging device 102 has a signal transmitter 123 that transmits a confirmation signal for confirming a connection state between the charging/discharging device 102 and the vehicle 101 to the vehicle 101. The signal transmitter 123 may be, for example, EVSE. The vehicle 101 has a signal receiver 113 that receives the confirmation signal. The signal receiver 113 may be, for example, an in-vehicle telematics unit. The charging/discharging management system 100 has a storage 106 that stores change information indicating a change in the first connection state information when the signal receiver 113 receives the confirmation signal. In the present embodiment, the storage 106 is provided in the management device 103. The determiner 105 determines the connection state between the charging/discharging device 102 and the vehicle 101 on the basis of the change information.

The storage 106 may be realized by a storage device such as a hard disk drive (HDD) or a flash memory, a detachable storage medium such as a DVD or a CD-ROM, an electrically erasable programmable read only memory (EEPROM), a read only memory (ROM), or a random access memory (RAM).

The charging/discharging management system 100 acquires various data by, for example, an in-vehicle telematics unit, EVSE, a simple storage service (S3), and the like.

The in-vehicle telematics unit is a source of information on, for example, a vehicle identification (ID), a measurement date and time, latitude, longitude, a fitting flag, and the like.

The EVSE is a source of information on, for example, a vehicle ID, a fitted state, an EVSE state, a vehicle's state of charge (SOC), a charging/discharging instruction value, and the like.

The S3 is a source of information on, for example, a vehicle ID, a reservation time zone, a driver ID, a departure point name, an arrival point name, and the like.

The charging/discharging management system 100 acquires, for example, information on the current time or the like via the Internet or the like.

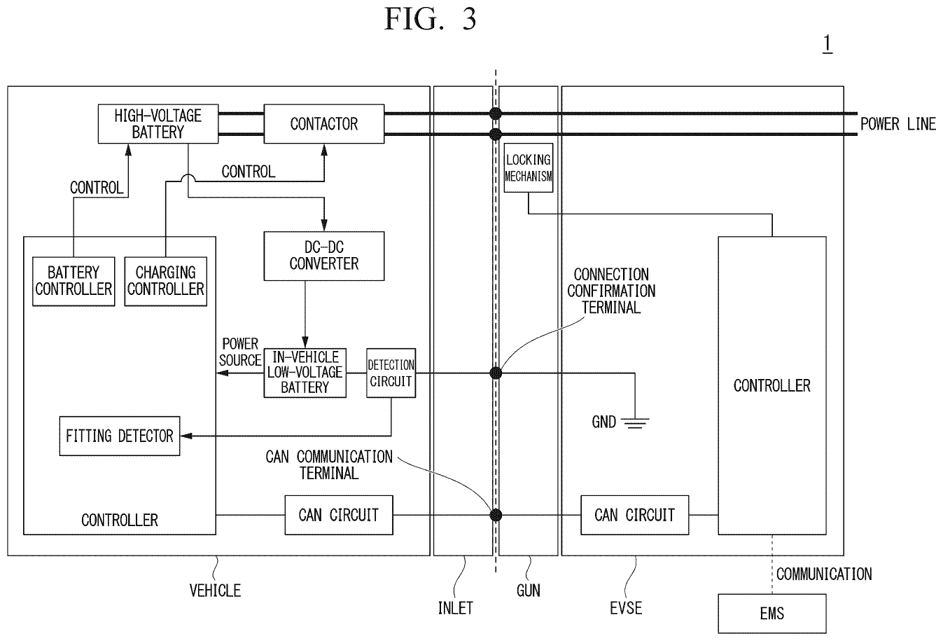

FIG. 3 is a diagram showing configurations on the vehicle 101 side and the EVSE side of the charging/discharging management system 100 according to the embodiment.

Referring to FIG. 3 together, a charging control system 1 configuring the charging/discharging management system 100 is configured to be able to charge the vehicle from an external power source by connecting a gun (charging gun) of a charger on the EVSE side to an inlet on the vehicle side.

The charger may not be a charging gun (gun type). For example, the charger may be a charging connector (connector type). In a case where the charger is a connector type, the charging connector provided at a tip of a charging cable (cable on the EVSE side) or the like may be connected to the inlet on the vehicle side so that the vehicle may be configured to be charged from an external power source. The form of the charger can be changed according to design specifications.

The vehicle includes the inlet on the vehicle side, a controller, a high-voltage battery, a contactor, a DC-DC converter, an in-vehicle low-voltage battery (for example, 12 V battery), a detection circuit, a CAN circuit, and the like. The constituent elements of the vehicle are electrically connected to elements related to each other by various wirings or the like.

The controller on the vehicle side includes a battery controller that controls the high-voltage battery, a charging controller that controls the contactor, and a fitting detector that is connected to the detection circuit and detects fitting. The controller on the vehicle side is communicable with a controller on the EVSE side via a CAN circuit, a CAN communication terminal, or the like. The controller (fitting detector) on the vehicle side is connectable to a ground (GND) on the EVSE side via the detection circuit, a connection confirmation terminal, or the like.

The EVSE includes a charging gun, a controller, a locking mechanism, a CAN circuit, and the like. The constituent elements of the EVSE are electrically connected to elements related to each other by various wirings or the like. The EVSE has a fitting flag of the charging gun that is linked to an operation of the locking mechanism. On the vehicle side, the fitted state of the charging gun is detected on the basis of the potential of the in-vehicle low-voltage battery (for example, 12 V battery) dropping to the ground (0 V) (for example, fluctuations of the ground) or the like.

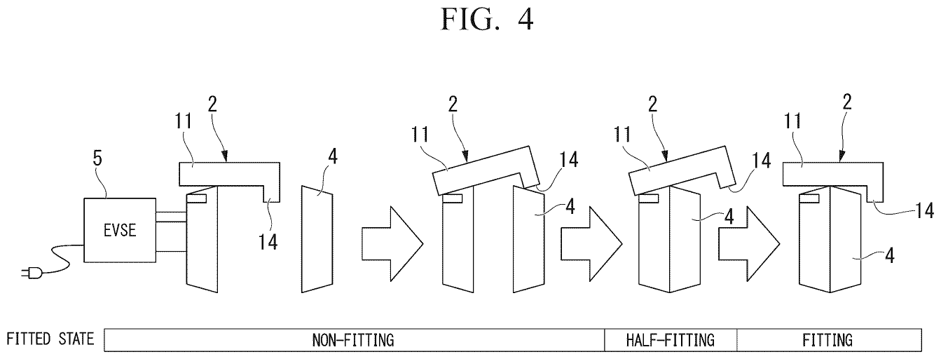

FIG. 4 is a diagram for explaining a change in the fitted state when the charging/discharging device 102 according to the embodiment is connected to the vehicle 101. FIG. 4 corresponds to a diagram showing a change in the fitted state when a charging gun 2 is connected to an inlet 4.

As shown in FIG. 4, the fitted state when the charging gun 2 is connected to the inlet 4 changes in the order of “non-fitting”, “half-fitting”, and “fitting”. Here, the non-fitting is a state in which the charging gun 2 is not connected to the inlet 4. The half-fitting is a state in which the charging gun 2 is connected to the inlet 4 but an engagement protrusion 14 has not completely lowered. The fitting is a state in which the charging gun 2 is connected to the inlet 4 and the engagement protrusion 14 has completely lowered.

The charging gun 2 has a switch 11 operable by a user. Hereinafter, the switch of the charging gun 2 may be referred to as an “S3 switch”. For example, the charging gun 2 is connected to a charging cable 5 (an example of the EVSE). The charging gun 2 is connected to the inlet 4 by fitting. The S3 switch 11 has the engagement protrusion 14 engageable with the inlet 4.

For example, the user can raise the engagement protrusion 14 and connect the charging gun 2 to the inlet 4 by pressing the S3 switch 11 when connecting the charging gun 2 to the inlet 4. Even if the user does not press the S3 switch 11 when connecting the charging gun 2 to the inlet 4, the user can push the charging gun 2 toward the inlet 4 to raise the engagement protrusion 14 and connect the charging gun 2 to the inlet 4. When the charging gun 2 is connected to the inlet 4, the engagement protrusion 14 is lowered, and the charging gun 2 is connected to the inlet 4 by fitting.

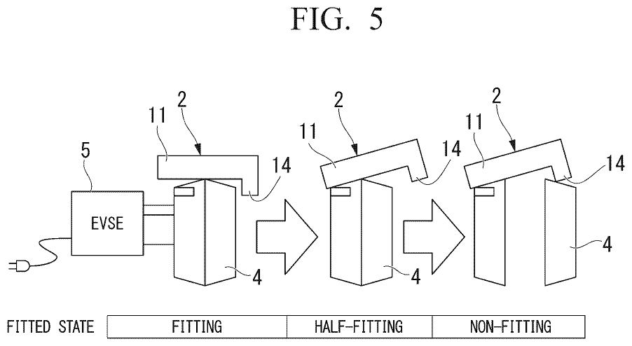

FIG. 5 is a diagram for explaining a change in the fitted state when the charging/discharging device 102 according to the embodiment is removed from the vehicle 101. FIG. 5 corresponds to a diagram showing a change in the fitted state when the charging gun 2 is removed from the inlet 4.

As shown in FIG. 5, the fitted state when the charging gun 2 is removed from the inlet 4 changes in the order of “fitting”, “half-fitting”, and “non-fitting”. For example, the user can raise the engagement protrusion 14 and pull out the charging gun 2 from the inlet 4 by pressing the S3 switch 11 when removing the charging gun 2 from the inlet 4. A configuration may be adopted in which when the user removes the charging gun 2 from the inlet 4, the engagement protrusion 14 is not raised and the charging gun 2 cannot be pulled out from the inlet 4 unless the S3 switch 11 is pressed.

### <Example of Confirming Connection of Charging Gun>

As shown in FIG. 3, the charging gun includes a connection confirmation terminal for confirming gun connection. The vehicle side has a voltage of 12 V. When the connection confirmation terminal of the charging gun is connected, the potential of 12 V on the vehicle side drops to the ground (0 V). Accordingly, fitting is recognized (fitting flag on the vehicle side).

### <Charging Gun>

FIG. 6 is a perspective view showing an example of the charging gun 2 and the inlet 4 according to the embodiment.

As shown in FIG. 6, the charging gun 2 is a gun-type charger provided on the equipment side. The charging gun 2 is configured to be insertable into and removable from the inlet 4 on the vehicle 101 side. The charging gun 2 includes a gun main body 10, the S3 switch 11 operable by the user, and a plug 12 connected to the inlet 4.

The S3 switch 11 is provided on an upper portion of the gun main body 10. The S3 switch 11 includes an operation protrusion 13 protruding from the gun main body 10 so as to be operable by the user, and the engagement protrusion 14 engageable with the inlet 4. For example, the user can operate the S3 switch 11 while gripping the gun main body 10 with one hand.

The plug 12 protrudes from the gun main body 10 toward the inlet 4. For example, the user can push the plug 12 toward the inlet 4 while gripping the gun main body 10.

### <Locking Mechanism>

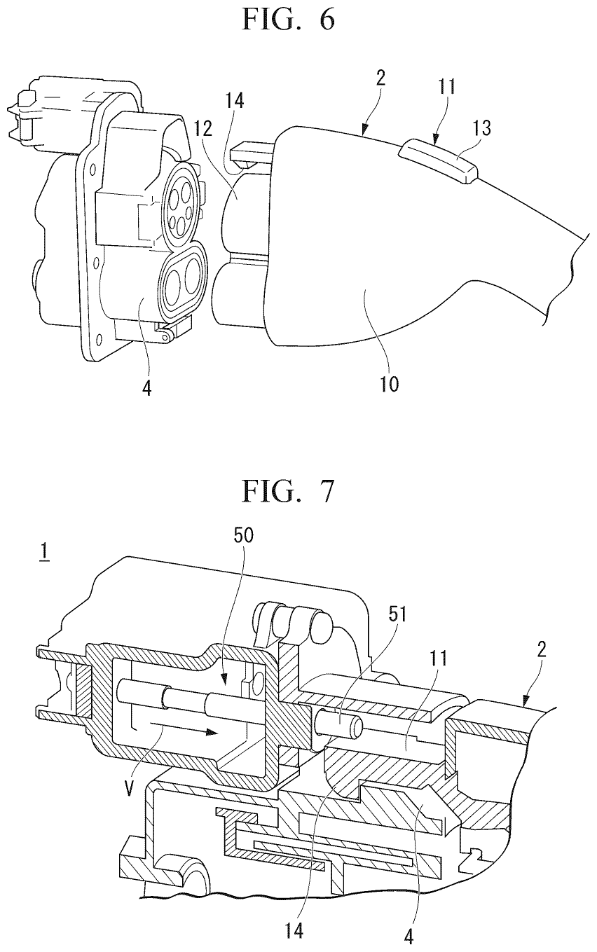

FIG. 7 is a perspective view including a cross section showing an example of a locking mechanism 50, the charging gun 2, and the inlet 4 according to the embodiment.

As shown in FIG. 7, the charging control system 1 includes the locking mechanism 50 that locks the charging gun 2 and the inlet 4. The locking mechanism 50 includes a locking pin 51 provided on the vehicle 101 side. For example, the locking pin 51 can be taken in and out (movable in a direction of an arrow V in FIG. 7 and a direction opposite to the direction of the arrow V) by an operation on the vehicle 101 side.

In the state of FIG. 7, the locking pin 51 protrudes from the vehicle 101 side toward the charging gun 2 side. For example, in a case where the locking pin 51 protrudes toward the charging gun 2 side in a state where the engagement protrusion 14 of the S3 switch 11 is engaged with the inlet 4, the S3 switch 11 is restrained by the locking pin 51. That is, the charging gun 2 is locked to the inlet 4. This makes it possible to prevent the charging gun 2 from being pulled out during energization.

### <Unlock Switch>

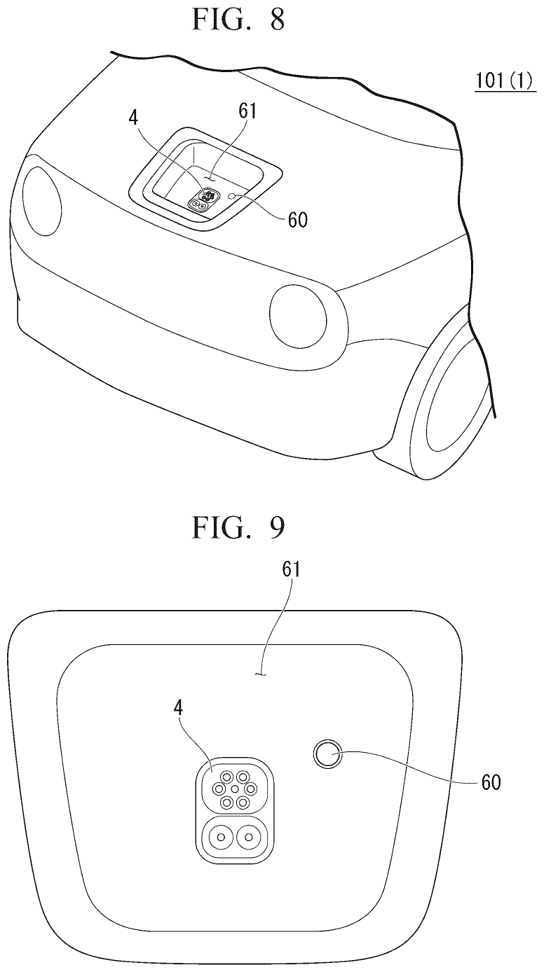

FIG. 8 is a perspective view showing an example of a front portion of the vehicle 101 according to the embodiment.

As shown in FIG. 8, the charging control system 1 includes an unlock switch 60 for releasing the lock between the charging gun 2 and the inlet 4. The unlock switch 60 is provided at the front portion of the vehicle 101. In the example of FIG. 8, the front portion of the vehicle 101 has a recess 61 recessed downward. The inlet 4 and the unlock switch 60 are provided on the bottom surface side of the recess 61. For example, a lid member (for example, openable/closable lid) that covers the recess 61 may be provided at the front portion of the vehicle 101.

FIG. 9 is a top view showing an example of the inlet and the unlock switch according to the embodiment.

As shown in FIG. 9, the inlet 4 is disposed at the center of the bottom surface of the recess 61 in top view. The unlock switch 60 is disposed on the side (right side in the drawing) of the inlet 4 in top view. For example, the unlock switch 60 may be operable by a smart key. For example, from the viewpoint of anti-theft properties, the unlock switch 60 may be operable only by the owner of the vehicle 101 (owner of the key).

For example, when the unlock switch 60 is pressed, the locking pin 51 moves in the direction opposite to the direction of the arrow V from the state of FIG. 7, and enters the vehicle 101 side (does not protrude toward the charging gun 2 side). When the locking pin 51 enters the vehicle 101 side, the S3 switch 11 is released from the restraint by the locking pin 51. That is, the lock between the charging gun 2 and the inlet 4 is released. As a result, the charging gun 2 can be pulled out.

### <Example of Fitting Flags of Vehicle and Charging/Discharging Device>

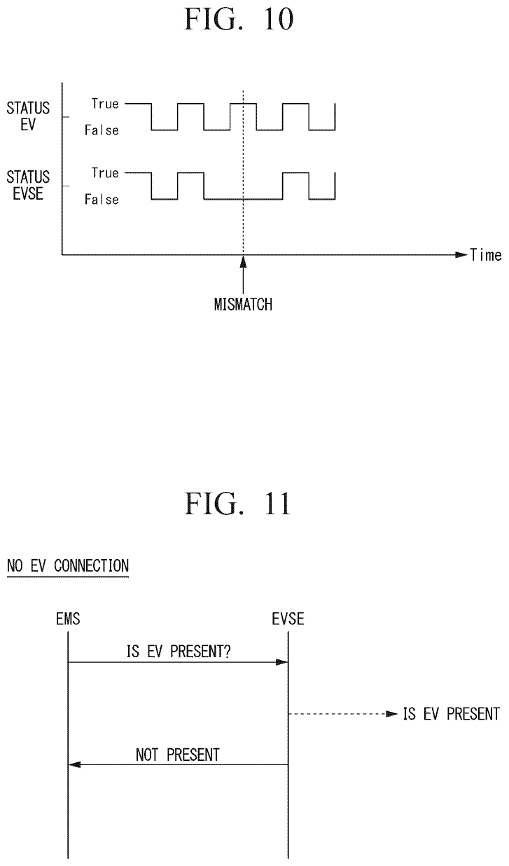

FIG. 10 is a diagram for explaining fitting flags of the vehicle 101 and the charging/discharging device 102 according to the embodiment. FIG. 10 shows a fitting flag of an EV (in-vehicle telematics unit) as the vehicle 101 and a fitting flag of EVSE (EMS) as the charging/discharging device 102.

As shown in an upper part of FIG. 10, the EV (in-vehicle telematics unit) has, as fitting flag information, a fitting flag being True (fitting flag True) and a fitting flag being False (fitting flag False). The fitting flag True on the EV side refers to a case where, for example, in a case where when the charging gun is connected (see FIG. 3), the controller on the vehicle side detects that the voltage of the circuit (detection circuit) corresponding to the connection confirmation terminal drops to the ground (0 V) on the EVSE side, and the fitting flag becomes True. The fitting flag False on the EV side refers to a case where, for example, in a case where no voltage is applied to the detection circuit, “non-fitting” is detected, and the fitting flag becomes False.

As shown in a lower part of FIG. 10, the EVSE (EMS) has, as fitting flag information, a fitting flag being True (fitting flag True) and a fitting flag being False (fitting flag False). The fitting flag True on the EVSE side refers to a case where, for example, in a case where the lock by the locking mechanism 50 is completed, “fitting” is detected, and the fitting flag becomes True. The fitting flag False on the EVSE side refers to a case where, for example, in a case where the lock by the locking mechanism 50 is released, “non-fitting” is detected, and the fitting flag becomes False.

As described above, in the present embodiment, the EV side and the EVSE side have the fitting flags separately from each other. On the EV side and the EVSE side, half-fitting is detected above and below the fitting flag. A fitting flag mismatch may occur between the EV side and the EVSE side. When the fitting flag on the EV side (an example of the first connection state information) and the fitting flag on the EVSE side (an example of the second connection state information) indicate different states, the determiner 105 determines that the connection state between the charging/discharging device 102 and the vehicle 101 is an invalid state (for example, half-fitted state). For example, when a state in which the fitting flag on the EV side and the fitting flag on the EVSE side do not match occurs a predetermined number of times, a charging/discharging instruction value of the EMS may be referred to in order to confirm that the state is not based on the charging/discharging instruction.

### <Example of Communication Operation for Each Situation>

FIG. 11 is a diagram for explaining a communication operation in a state where the charging/discharging device 102 according to the embodiment is not connected to the vehicle 101. FIG. 11 shows an example of a communication operation in a state where the EVSE is not connected to the EV (no EV connection).

As shown in FIG. 11, the EMS transmits a signal for confirming whether the EVSE is connected to the EV (whether the EV is present) to the EVSE. When receiving the signal from the EMS, the EVSE transmits a signal for confirming whether the EV is present to the EV. In the example of FIG. 11, since there is no EV connection, the EVSE returns no signal or transmits a signal indicating that there is no EV to the EMS.

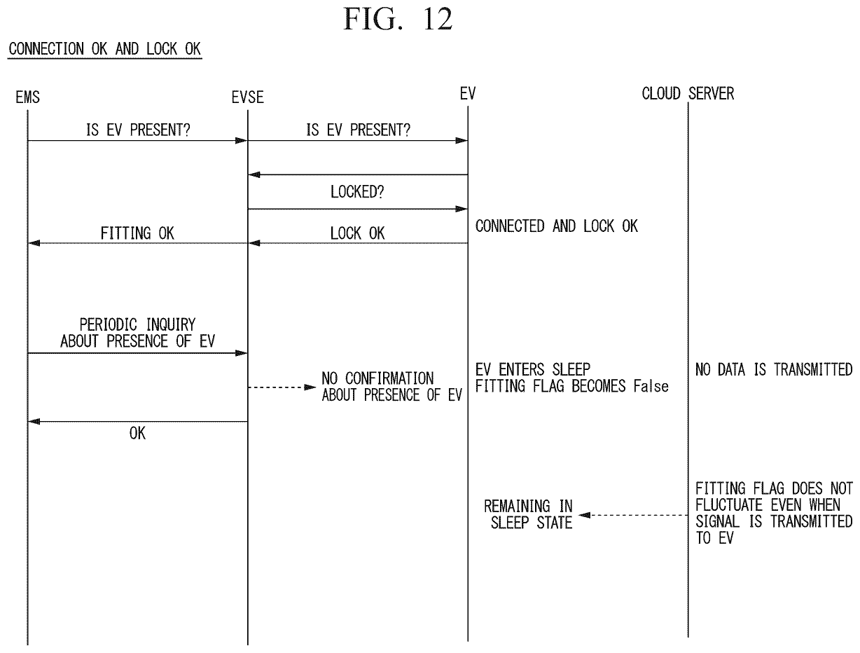

FIG. 12 is a diagram for explaining a communication operation in a state where the charging/discharging device 102 according to the embodiment is connected to the vehicle 101 (fitted state). FIG. 12 shows an example of a communication operation in a state where the EVSE is connected to the EV in a normally-fitted state (connection OK and lock OK).

As shown in FIG. 12, the EMS transmits a signal for confirming whether the EVSE is connected to the EV (whether the EV is present) to the EVSE. When receiving the signal from the EMS, the EVSE transmits a signal for confirming whether the EV is present and whether it is locked to the EV. In the example of FIG. 12, since the fitted state is normal, the EVSE transmits a signal indicating “fitting OK” to the EMS on the basis of the lock OK.

In the example of FIG. 12, the EMS periodically transmits a signal for confirming whether the EVSE is connected to the EV (whether the EV is present) to the EVSE (periodic inquiry). Even when receiving the signal (periodic inquiry) from the EMS, the EVSE does not transmit a signal for confirming whether the EV is present and whether it is locked to the EV since it is clear that the fitted state is normal. Then, the EV enters a non-activation state (sleep). When the EV enters sleep (when the vehicle 101 is off), the fitting flag becomes False. When the vehicle 101 is off, data is not transmitted from the EV to the cloud server. Even when a signal is transmitted from the cloud server to the EV, the fitting flag does not fluctuate up and down (remains constant) since the EV remains in the sleep state.

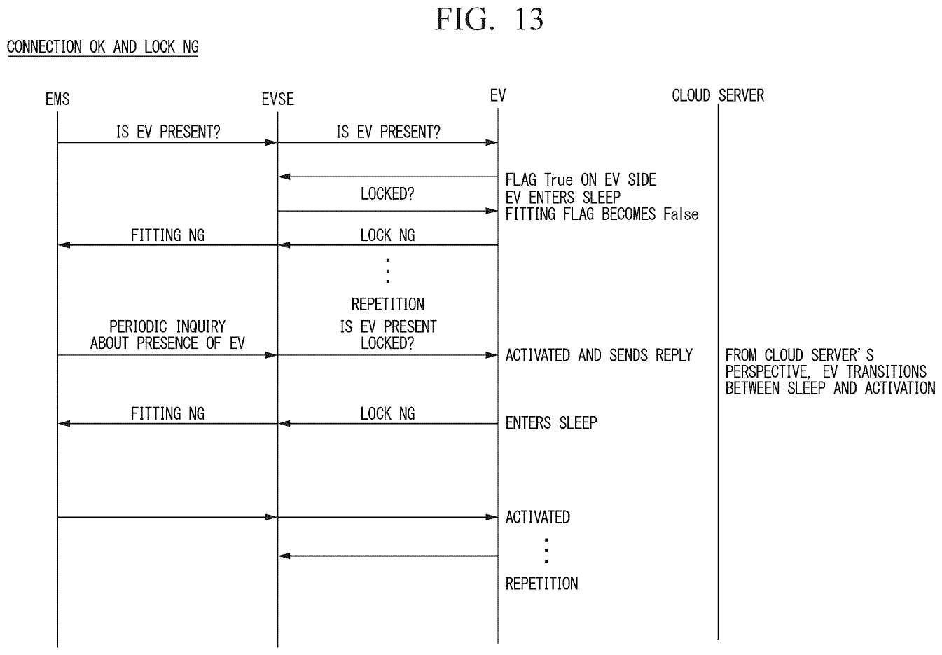

FIG. 13 is a diagram for explaining a communication operation in a state where the charging/discharging device 102 according to the embodiment is connected to the vehicle 101(half-fitted state). FIG. 13 shows an example of a communication operation in a state where the EVSE is connected to the EV in a half-fitted state (connection OK and lock NG).

As shown in FIG. 13, the EMS transmits a signal for confirming whether the EVSE is connected to the EV (whether the EV is present) to the EVSE. When receiving the signal from the EMS, the EVSE transmits a signal for confirming whether the EV is present and whether it is locked to the EV. Since it is not locked in the example of FIG. 13, the EVSE transmits a signal indicating “fitting NG” to the EMS.

In the example of FIG. 13, the EMS periodically transmits a signal for confirming whether the EVSE is connected to the EV (whether the EV is present) to the EVSE (periodic inquiry). When receiving the signal (periodic inquiry) from the EMS, the EVSE transmits a signal for confirming whether the EV is present to the EV due to not being fitted. The EV is in a non-activation state (sleep) due to connection OK (fitting flag True on the EV side). When receiving the signal from the EVSE, the EV returns from sleep to the activation state, and transmits the signal to the EVSE (periodic reply). Even when receiving the signal (periodic reply) from the EV, the EVSE does not return a signal or transmits a signal indicating that there is no EV to the EMS. From the cloud server's perspective, the EV is repeating its entering sleep and activation (raising and lowering the flag). The cloud server transmits a signal for confirming (fact-checking) the EV's flag raising and lowering to the EMS. Then, it is found that the EV's flag raising and lowering are not due to the instruction (for example, charging/discharging instruction) from EMS.

### <Example of Fitting Alert System>

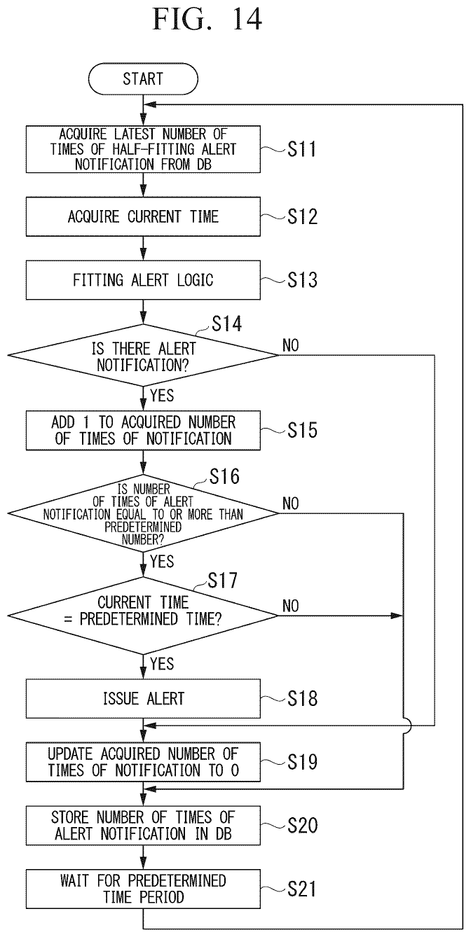

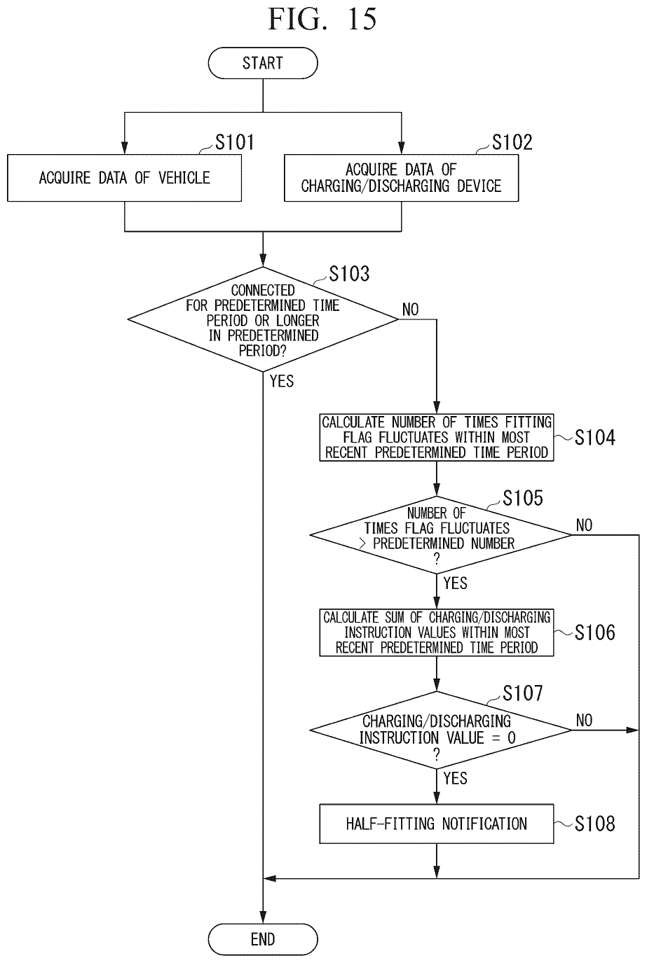

FIG. 14 is a flowchart showing an example of a fitting alert system according to the embodiment. In the fitting alert system shown in FIG. 14, an alarm timing is set every predetermined time period (for example, 30 minutes).

As shown in FIG. 14, in Step S11, the determiner 105 acquires the latest number of times of half-fitting alert notification from a database (DB). The latest number of times of half-fitting alert notification corresponds to the number of times of detection of the half-fitted state within the most recent predetermined time period (for example, within the most recent 1 hour or within the most recent 30 minutes). After Step S11, the process proceeds to Step S12.

In Step S12, the determiner 105 acquires the current time. The information on the current time is acquired, for example, via the Internet. After Step S12, the process proceeds to Step S13.

In Step S13, the determiner 105 executes a fitting alert logic. Examples of the fitting alert logic will be described later (see FIGS. 15 to 17). After Step S13, the process proceeds to Step S14.

In Step S14, the determiner 105 determines whether there is an alert notification. For example, the determiner 105 determines that there is an alert notification in a case where the “fitting alert logic” to be described later is a flow for alert notification. In a case where it is determined that there is an alert notification (YES in Step S14), the process proceeds to Step S15. In contrast, in a case where it is determined that there is no alert notification (NO in Step S14), the process proceeds to Step S19.

In Step S15, the determiner 105 adds 1 to the acquired number of times of notification. After Step S15, the process proceeds to Step S16.

In Step S16, the determiner 105 determines whether the number of times of alert notification is equal to or more than a predetermined number. The predetermined number is set to, for example, 2 or more. In a case where it is determined that the number of times of alert notification is equal to or more than 2 (YES in Step S16), the process proceeds to Step S17. In contrast, in a case where it is determined that the number of times of alert notification is not equal to or more than 2 (NO in Step S16), the process proceeds to Step S20.

In Step S17, the determiner 105 determines whether the current time is a predetermined time. The predetermined time is set to, for example, XX:00 or XX:30.In a case where it is determined that the current time is XX:00 or XX:30 (YES in Step S17), the process proceeds to Step S18. In contrast, in a case where it is determined that the current time is not XX:00 or XX:30 (NO in Step S17), the process proceeds to Step S20.

In Step S18, the determiner 105 issues an alert. The alert may be issued, for example, by displaying an alert message on the device (for example, display device) that is used by the user, or by emitting an alert sound (warning sound). After Step S18, the process proceeds to Step S19.

In Step S19, the determiner 105 updates the acquired number of times of notification to 0. For example, the determiner 105 sets the acquired number of times of alert notification to 0 even if the number of times of alert notification acquired is 2 or more in Step S16. After Step S19, the process proceeds to Step S20.

In Step S20, the determiner 105 stores the number of times of alert notification in the database (DB). For example, the determiner 105 stores the number of times of alert notification as 0 in the DB. After Step S20, the process proceeds to Step S21.

In Step S21, the determiner 105 waits for a predetermined time period. The predetermined time period is set to, for example, 10 minutes or 20 minutes. After Step S21, the process returns to before Step S11.

### <First Example of Fitting Alert Logic>

FIG. 15 is a flowchart showing a first example of the fitting alert logic according to the embodiment. The fitting alert logic shown in FIG. 15 is set every predetermined time period (for example, 10 minutes).

As shown in FIG. 15, in Step S101, the determiner 105 acquires data of the vehicle 101. For example, the determiner 105 acquires data (for example, information on a vehicle ID, a measurement date and time, latitude, longitude, a fitting flag, and the like) of the EV (for example, in-vehicle telematics unit) for a predetermined time period (for example, 1 hour or 30 minutes). After Step S101, the process proceeds to Step S103.

In Step S102, the determiner 105 acquires data of the charging/discharging device 102. For example, the determiner 105 acquires data (for example, information on a vehicle ID, a fitted state, an EVSE state, a vehicle's SOC, a charging/discharging instruction value, and the like) of the EVSE (EMS) for a predetermined time period (for example, 1 hour or 30 minutes). After Step S102, the process proceeds to Step S103.

In Step S103, the determiner 105 determines whether the EVSE has been connected for a predetermined time period or longer in a predetermined period. For example, the determiner 105 determines whether the EV and the EVSE have been connected for 1 minute or longer in the past 30 minutes. For example, the determiner 105 makes the determination on the basis of the fitted state information included in the data of the EVSE acquired in Step S102. In a case where it is determined that the EV and the EVSE have been connected for 1 minute or longer in the past 30 minutes (YES in Step S103), the process ends. In contrast, in a case where it is determined that the EV and the EVSE have not been connected for 1 minute or longer in the past 30 minutes (NO in Step S103), the process proceeds to Step S104.

In Step S104, the determiner 105 calculates the number of times the fitting flag on the EV side fluctuates within the most recent predetermined time period (for example, 1 hour). The number of times the fitting flag fluctuates corresponds to the number of times the fitting flag repeatedly changes between True and False. After Step S104, the process proceeds to Step S105.

In Step S105, the determiner 105 determines whether the number of times the flag fluctuates is more than a predetermined number. For example, the determiner 105 determines whether the number of times the fitting flag (an example of the first connection state information) on the EV side fluctuates is more than 6 within the most recent 1 hour. In a case where it is determined that the number of times the fitting flag on the EV side fluctuates is more than 6 (YES in Step S105), the process proceeds to Step S106. In contrast, in a case where it is determined that the number of times the fitting flag on the EV side fluctuates is not more than 6 (NO in Step S105), the process ends. Steps S104 and S105 are an example of a flow for determining the connection state between the charging/discharging device 102 and the vehicle 101 by the determiner 105 on the basis of the fact that the number of times the first connection state information changes is more than a predetermined number in a predetermined period.

In S106, the determiner 105 calculates the sum of charging/discharging instruction values (EMS instruction values) on the EVSE (EMS) side within the most recent predetermined time period (for example, 1 hour). After S106, the process proceeds to S107.

In S107, the determiner 105 determines whether the charging/discharging instruction value is 0. In a case where it is determined that the charging/discharging instruction value is 0 (YES in S107), the process proceeds to Step S108. In contrast, in a case where it is determined that the charging/discharging instruction value is not 0 (NO in S107), the process ends. Step S107 is an example of a flow for determining the connection state between the charging/discharging device 102 and the vehicle 101 by the determiner 105 on the basis of whether the charging/discharging instruction value is 0 in a predetermined period.

In S108, the determiner 105 executes half-fitting notification. For example, the determiner 105 takes a flow for “alert notification” in Step S14 shown in FIG. 14 in a case where a half-fitted state is detected. For example, as a fitting alert (half-fitting notification), a half-fitting alert may be issued when the number of times the fitting flag fluctuates is more than 6 within the most recent 1 hour and the charging/discharging instruction value is 0. After Step S108, the process ends. Steps S106 to S108 are an example of a flow for determining the connection state between the charging/discharging device 102 and the vehicle 101 by the determiner 105 on the basis of the charging/discharging instruction value received by the charging/discharging device 102 in a predetermined period.

### <Second Example of Fitting Alert Logic>

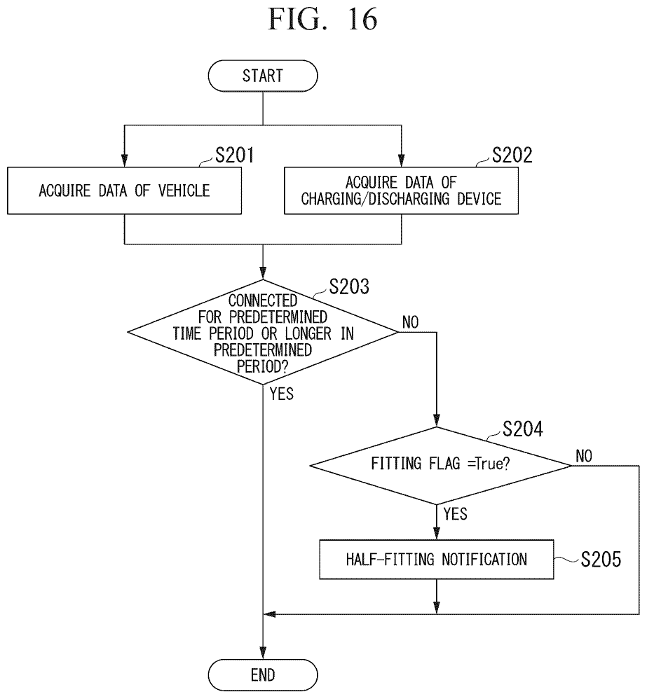

FIG. 16 is a flowchart showing a second example of the fitting alert logic according to the embodiment. The second example of the fitting alert logic is a valid logic in a case where the vehicle enters sleep with the fitting flag being True. The second example of the fitting alert logic differs from the above-described premise (the premise that the flag becomes False when the vehicle enters sleep). The fitting alert logic shown in FIG. 16 is set every predetermined time period (for example, 10 minutes).

As shown in FIG. 16, in Step S201, the determiner 105 acquires data of the vehicle 101. For example, the determiner 105 acquires data (for example, information on a vehicle ID, a measurement date and time, latitude, longitude, a fitting flag, and the like) of the EV (for example, in-vehicle telematics unit) for a predetermined time period (for example, 1 hour or 30 minutes). After Step S201, the process proceeds to Step S203.

In Step S202, the determiner 105 acquires data of the charging/discharging device 102. For example, the determiner 105 acquires data (for example, information on a vehicle ID, a fitted state, an EVSE state, a vehicle's SOC, a charging/discharging instruction value, and the like) of the EVSE (EMS) for a predetermined time period (for example, 1 hour or 30 minutes). After Step S202, the process proceeds to Step S203.

In Step S203, the determiner 105 determines whether the EVSE has been connected for a predetermined time period or longer in a predetermined period. For example, the determiner 105 determines whether the EV and the EVSE have been connected for 1 minute or longer in the past 30 minutes. In a case where it is determined that the EV and the EVSE have been connected for 1 minute or longer in the past 30 minutes (YES in Step S203), the process ends. In contrast, in a case where it is determined that the EV and the EVSE have not been connected for 1 minute or longer in the past 30 minutes (NO in Step S203), the process proceeds to Step S204.

In Step S204, the determiner 105 determines whether the fitting flag on the EV side is True. In a case where it is determined that the fitting flag on the EV side is True (YES in Step S204), the process proceeds to Step S205. In a case where it is determined that the fitting flag on the EV side is not True (NO in Step S204), the process ends.

In Step S205, the determiner 105 executes half-fitting notification. For example, the determiner 105 takes a flow for “alert notification” in Step S14 shown in FIG. 14 in a case where a half-fitted state is detected. After Step S205, the process ends.

### <Third Example of Fitting Alert Logic>

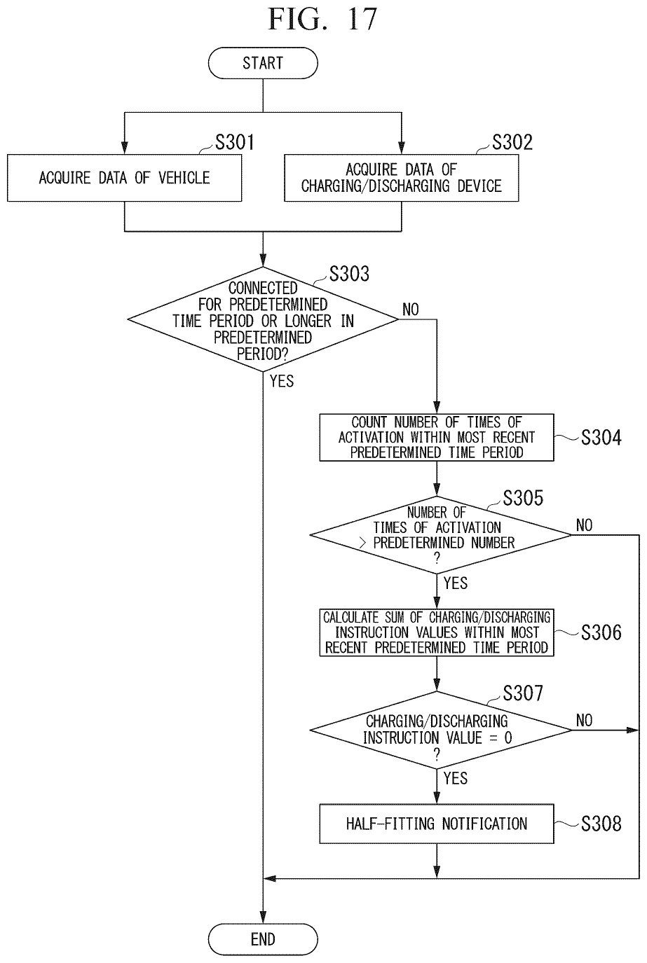

FIG. 17 is a flowchart showing a third example of the fitting alert logic according to the embodiment. The third example of the fitting alert logic is a valid logic in a case where the vehicle enters sleep with the fitting flag being True. The third example of the fitting alert logic differs from the above-described premise (the premise that the flag becomes False when the vehicle enters sleep). The fitting alert logic shown in FIG. 17 is set every predetermined time period (for example, 10 minutes).

As shown in FIG. 17, in Step S301, the determiner 105 acquires data of the vehicle 101. For example, the determiner 105 acquires data (for example, information on a vehicle ID, a measurement date and time, latitude, longitude, a fitting flag, and the like) of the EV (for example, in-vehicle telematics unit) for a predetermined time period (for example, 1 hour or 30 minutes). After Step S301, the process proceeds to Step S303.

In Step S302, the determiner 105 acquires data of the charging/discharging device 102. For example, the determiner 105 acquires data (for example, information on a vehicle ID, a fitted state, an EVSE state, a vehicle's SOC, a charging/discharging instruction value, and the like) of the EVSE (EMS) for a predetermined time period (for example, 1 hour or 30 minutes). After Step S302, the process proceeds to Step S303.

In Step S303, the determiner 105 determines whether the EVSE has been connected for a predetermined time period or longer in a predetermined period. For example, the determiner 105 determines whether the EV and the EVSE have been connected for 1 minute or longer in the past 30 minutes. In a case where it is determined that the EV and the EVSE have been connected for 1 minute or longer in the past 30 minutes (YES in Step S303), the process ends. In contrast, in a case where it is determined that the EV and the EVSE have not been connected for 1 minute or longer in the past 30 minutes (NO in Step S303), the process proceeds to Step S304.

In Step S304, the determiner 105 counts the number of times of activation (an example of other state information different from the first connection state information) on the EV side within the most recent predetermined time period (for example, 30 minutes). The number of times of activation on the EV side corresponds to the number of times the EV is repeatedly switched from activation-on to activation-off in a predetermined period. After Step S304, the process proceeds to Step S305.

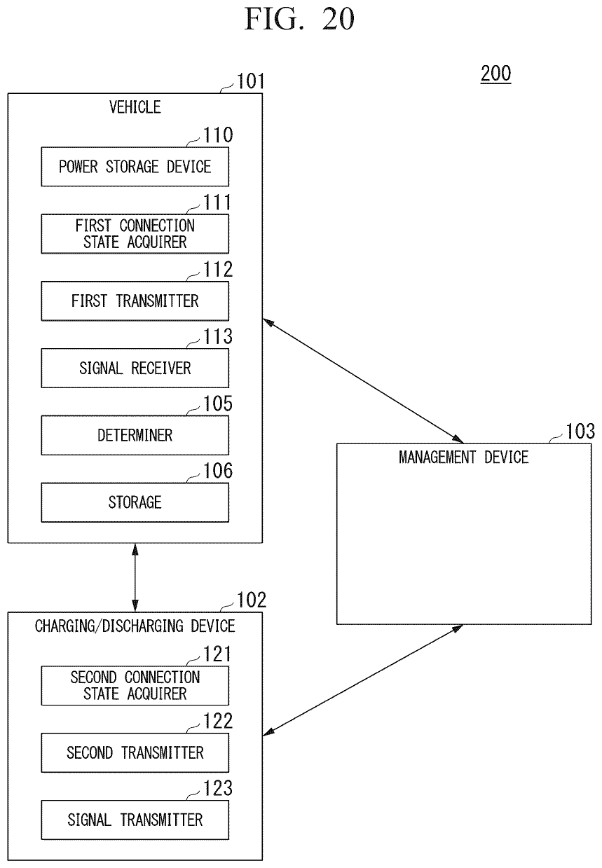

In Step S305, the determiner 105 determines whether the number of times of activation is more than a predetermined number. For example, the determiner 105 determines whether the number of times of EV activation is more than a reference number within the most recent 30 minutes. The reference number is set on the basis of the number of times the general vehicle (EV) 101 is repeatedly switched from activation-on to activation-off in a predetermined period. The reference number for the number of times of activation may be set on the basis of fluctuations in the activation voltage (see FIG. 19) in a predetermined period.

In a case where it is determined that the number of times of activation is more than the reference number (YES in Step S305), the process proceeds to Step S306. In contrast, in a case where it is determined that the number of times of activation is not more than the reference number (NO in Step S305), the process ends. Steps S304 and S305 are an example of a flow for determining the connection state between the charging/discharging device 102 and the vehicle 101 by the determiner 105 on the basis of the fact that the number of times other state information changes is more than a predetermined number in a predetermined period.

In S306, the determiner 105 calculates the sum of charging/discharging instruction values (EMS instruction values) on the EVSE (EMS) side within the most recent predetermined time period (for example, 1 hour). After S306, the process proceeds to S307.

In S307, the determiner 105 determines whether the charging/discharging instruction value is 0. In a case where it is determined that the charging/discharging instruction value is 0 (YES in S307), the process proceeds to Step S308. In contrast, in a case where it is determined that the charging/discharging instruction value is not 0 (NO in S307), the process ends. Step S307 is an example of a flow for determining the connection state between the charging/discharging device 102 and the vehicle 101 by the determiner 105 on the basis of whether the charging/discharging instruction value is 0 in a predetermined period.

In S308, the determiner 105 executes half-fitting notification. For example, the determiner 105 takes a flow for “alert notification” in Step S14 shown in FIG. 14 in a case where a half-fitted state is detected. For example, as a fitting alert (half-fitting notification), a half-fitting alert may be issued when the number of times of activation is more than a reference number within the most recent 1 hour and the charging/discharging instruction value is 0. After Step S308, the process ends. Steps S306 to S308 are an example of a flow for determining the connection state between the charging/discharging device 102 and the vehicle 101 by the determiner 105 on the basis of the charging/discharging instruction value received by the charging/discharging device 102 in a predetermined period. In addition, this flow is on the basis of the second connection state information and the change information of other state information, and is not on the basis of the first connection state information. This flow is an example of a flow for determining the connection state between the charging/discharging device 102 and the vehicle 101 on the basis of other state information different from the first connection state information.

### <Example of Determination of Connection State>

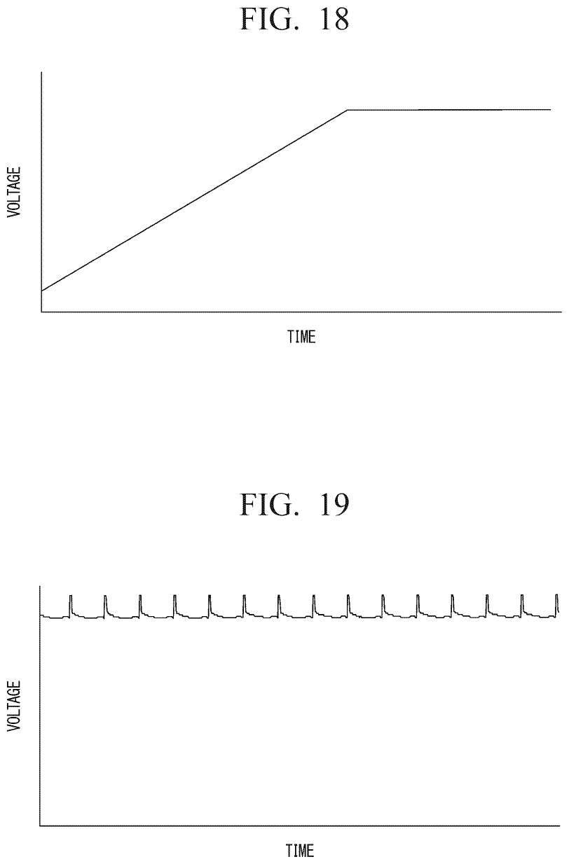

FIG. 18 is a diagram showing an example of a temporal change in the activation voltage during normal fitting according to the embodiment.

As shown in FIG. 18, the activation voltage during normal fitting rises when fitting is performed from the activation-off state (sleep) and charging is started at a predetermined time. After the activation voltage during normal fitting rises, the activation voltage does not fluctuate (becomes constant) and charging ends.

FIG. 19 is a diagram showing an example of a temporal change in the activation voltage during half-fitting according to the embodiment.

As shown in FIG. 19, the activation voltage during half-fitting continuously fluctuates in the activation-off state with the fitting flag being True. For example, the interval (time) at which the activation voltage during half-fitting fluctuates corresponds to the connection confirmation cycle of the EMS.

For example, the EMS transmits a signal for confirming the connection to the EV at a predetermined interval, and the determiner 105 determines the connection state between the EVSE and the EV on the basis of the transmission interval of the confirmation signal and the fluctuation interval of the activation voltage. The above-described example corresponds to an example in which the signal transmitter 123 transmits a confirmation signal to the vehicle 101 at a predetermined interval, and the determiner 105 determines the connection state between the charging/discharging device 102 and the vehicle 101 on the basis of the predetermined interval and an interval of the change information.

### <Operation and Effects>

As described above, the charging/discharging management system 100 according to the above embodiment is a charging/discharging management system 100 including a vehicle 101 including a power storage device 110, a charging/discharging device 102 that performs charging or discharging for the vehicle 101, and a management device 103 that manages charging/discharging, in which the vehicle 101 has a first connection state acquirer 111 that acquires first connection state information indicating a connection state between the charging/discharging device 102 and the vehicle 101, and a first transmitter 112 that transmits the first connection state information to the management device 103, the charging/discharging device 102 has a second connection state acquirer 121 that acquires second connection state information indicating a connection state between the charging/discharging device 102 and the vehicle 101, and a second transmitter 122 that transmits the second connection state information to the management device 103, and the charging/discharging management system 100 has a determiner 105 that determines a connection state between the charging/discharging device 102 and the vehicle 101 on the basis of the first connection state information and the second connection state information.

According to this configuration, it is possible to determine the connection state between the charging/discharging device 102 and the vehicle 101 after collecting and comparing both the first connection state information and the second connection state information. Therefore, it is not necessary to provide a dedicated circuit or device that detects the connection state on the vehicle 101 side and the charging/discharging device 102 side. Therefore, it is possible to suppress an increase in cost and a deterioration in convenience.

In the embodiment, at least one of the first connection state information and the second connection state information indicates fitting or non-fitting as the connection state between the charging/discharging device 102 and the vehicle 101.

According to this configuration, it is possible to determine the connection state between the charging/discharging device 102 and the vehicle 101 after comparing the fitting or non-fitting indicated by at least one of the first connection state information and the second connection state information.

In the embodiment, when the first connection state information and the second connection state information indicate different states, the determiner 105 determines that the connection state between the charging/discharging device 102 and the vehicle 101 is an invalid state.

According to this configuration, in a case where the first connection state information and the second connection state information indicate different states, it can be determined that the connection state between the charging/discharging device 102 and the vehicle 101 is an invalid state. Therefore, it is possible to accurately detect an invalid state (for example, half-fitted state) without requiring a dedicated circuit or device on the vehicle 101 side and the charging/discharging device 102 side.

In the embodiment, the charging/discharging device 102 has a signal transmitter 123 that transmits a confirmation signal for confirming the connection state between the charging/discharging device 102 and the vehicle 101 to the vehicle 101, the vehicle 101 has a signal receiver 113 that receives the confirmation signal, the charging/discharging management system 100 has a storage 106 that stores change information indicating a change in the first connection state information when the signal receiver 113 receives the confirmation signal, and the determiner 105 determines the connection state between the charging/discharging device 102 and the vehicle 101 on the basis of the change information.

According to this configuration, it is possible to determine the connection state between the charging/discharging device 102 and the vehicle 101 on the basis of the change information indicating a change in the first connection state information. For example, in a case where the first connection state information changes when the second connection state information indicates non-fitting, half-fitting can be more accurately detected. For example, the half-fitted state can be detected on the basis of the change information indicating a change in the fitting flag on the vehicle side.

In the embodiment, the determiner 105 determines the connection state between the charging/discharging device 102 and the vehicle 101 on the basis of the fact that the number of times the first connection state information changes is more than a predetermined number in a predetermined period.

According to this configuration, redundancy can be provided, which can improve reliability and availability of the system. For example, it is possible to determine the connection state between the charging/discharging device 102 and the vehicle 101 on the basis of the fact that the number of times the fitting flag on the vehicle side fluctuates is more than a predetermined number within a predetermined time period.

In the embodiment, the determiner 105 determines the connection state between the charging/discharging device 102 and the vehicle 101 on the basis of a charging/discharging instruction value received by the charging/discharging device 102 in a predetermined period.

According to this configuration, it is possible to determine the connection state between the charging/discharging device 102 and the vehicle 101 on the basis of a charging/discharging instruction value in a predetermined period. For example, it is possible to prevent erroneous notification in a case where the connection state information changes on the basis of the charging/discharging instruction value.

In the embodiment, the determiner 105 determines the connection state between the charging/discharging device 102 and the vehicle 101 on the basis of whether the charging/discharging instruction value is 0 in the predetermined period.

According to this configuration, it is possible to determine the connection state between the charging/discharging device 102 and the vehicle 101 on the basis of whether the charging/discharging instruction value is 0 in the predetermined period. For example, in a case where the connection state information changes even though there is no charging/discharging instruction, it can be determined that the connection state is invalid (for example, half-fitting), which is more accurate.

In the embodiment, the signal transmitter 123 transmits the confirmation signal to the vehicle 101 at a predetermined interval, and the determiner 105 determines the connection state between the charging/discharging device 102 and the vehicle 101 on the basis of the predetermined interval and an interval of the change information.

According to this configuration, it is possible to determine the connection state between the charging/discharging device 102 and the vehicle 101 on the basis of the predetermined interval and an interval of the change information. For example, it can be confirmed that the connection state information changes by the signal from the charging/discharging device 102, allowing for more accurate determination. For example, it is possible to determine the connection state between the charging/discharging device 102 and the vehicle 101 on the basis of the transmission interval of the confirmation signal and the fluctuation interval of the fitting flag on the vehicle side.

In the embodiment, the charging/discharging device 102 has a signal transmitter 123 that transmits a confirmation signal for confirming the connection state between the charging/discharging device 102 and the vehicle 101 to the vehicle 101, the vehicle 101 has a signal receiver 113 that receives the confirmation signal, the charging/discharging management system 100 has a storage 106 that stores change information indicating a change in other state information different from the first connection state information when the signal receiver 113 receives the confirmation signal, and the determiner 105 determines the connection state between the charging/discharging device 102 and the vehicle 101 on the basis of the change information.

According to this configuration, it is possible to determine the connection state between the charging/discharging device 102 and the vehicle 101 on the basis of the change information indicating a change in other state information different from the first connection state information. For example, in a case where other state information (for example, activation state information of the vehicle 101) changes when the connection state between the charging/discharging device 102 and the vehicle 101 is non-fitting, half-fitting can be more accurately detected.

In the embodiment, the determiner 105 determines the connection state between the charging/discharging device 102 and the vehicle 101 on the basis of the fact that the number of times the other state information changes is more than a predetermined number in a predetermined period.

According to this configuration, redundancy can be provided, which can improve reliability and availability of the system. For example, it is possible to determine the connection state between the charging/discharging device 102 and the vehicle 101 on the basis of the fact that the number of times the vehicle 101 is activated is more than a predetermined number within a predetermined time period.

In the embodiment, the determiner 105 determines the connection state between the charging/discharging device 102 and the vehicle 101 on the basis of a charging/discharging instruction value received by the charging/discharging device 102 in a predetermined period.

According to this configuration, it is possible to determine the connection state between the charging/discharging device 102 and the vehicle 101 on the basis of a charging/discharging instruction value in a predetermined period. For example, it is possible to prevent erroneous notification in a case where other state information (for example, activation state information of the vehicle 101) changes on the basis of the charging/discharging instruction value.

In the embodiment, the determiner 105 determines the connection state between the charging/discharging device 102 and the vehicle 101 on the basis of whether the charging/discharging instruction value is 0 in the predetermined period.

According to this configuration, it is possible to determine the connection state between the charging/discharging device 102 and the vehicle 101 on the basis of whether the charging/discharging instruction value is 0 in the predetermined period. For example, in a case where other state information (for example, activation state information of the vehicle 101) changes even though there is no charging/discharging instruction, it can be determined that the connection state is invalid (for example, half-fitting), which is more accurate.

In the embodiment, the signal transmitter 123 transmits the confirmation signal to the vehicle 101 at a predetermined interval, and the determiner 105 determines the connection state between the charging/discharging device 102 and the vehicle 101 on the basis of the predetermined interval and an interval of the change information.

According to this configuration, it is possible to determine the connection state between the charging/discharging device 102 and the vehicle 101 on the basis of the predetermined interval and an interval of the change information. For example, it can be confirmed that other state information (for example, activation state information of the vehicle 101) changes by the signal from the charging/discharging device 102, allowing for more accurate determination. For example, it is possible to determine the connection state between the charging/discharging device 102 and the vehicle 101 on the basis of the transmission interval of the confirmation signal and the fluctuation interval of the activation voltage.

In the embodiment, the determiner 105 is provided in the management device 103.

According to this configuration, it is possible to determine the connection state between the charging/discharging device 102 and the vehicle 101 after collecting and comparing both the first connection state information and the second connection state information in the management device 103. Therefore, it is not necessary to provide a dedicated circuit or device that detects the connection state on the vehicle 101 side and the charging/discharging device 102 side. Therefore, it is possible to suppress an increase in cost and a deterioration in convenience. For example, by transmitting fitting flags from the EVSE (EMS) and the EV (in-vehicle telematics unit) and comparing both the flags in an upper-level server (cloud server), it is possible to provide a system capable of detecting “half-fitting” with high versatility even in equipment having no dedicated circuit or device.

### Second Embodiment

Hereinafter, a charging/discharging management system 200 according to a second embodiment will be described. In the following description, portions having the same functions as those described in the above-described embodiment will be denoted by the same names and references, and detailed description thereof will be omitted.

FIG. 20 is a block diagram showing a configuration of the charging/discharging management system 200 according to the second embodiment.

As shown in FIG. 20, the charging/discharging management system 200 includes a vehicle 101 including a power storage device 110, a charging/discharging device 102 that performs charging or discharging for the vehicle 101, and a management device 103 that manages charging/discharging. The vehicle 101, the charging/discharging device 102, and the management device 103 are communicable with each other through a multiplex communication line such as a CAN communication line, a serial communication line, a wireless communication network, or the like.

The vehicle 101 has a first connection state acquirer 111 that acquires first connection state information indicating a connection state between the charging/discharging device 102 and the vehicle 101, and a first transmitter 112 that transmits the first connection state information to the management device 103. The charging/discharging device 102 has a second connection state acquirer 121 that acquires second connection state information indicating a connection state between the charging/discharging device 102 and the vehicle 101, and a second transmitter 122 that transmits the second connection state information to the management device 103.

In the second embodiment, the vehicle 101 has a determiner 105 that determines a connection state between the charging/discharging device 102 and the vehicle 101 on the basis of the first connection state information and the second connection state information. In the second embodiment, the determiner 105 is not provided in the management device 103 but is provided in the vehicle 101.

The charging/discharging device 102 has a signal transmitter 123 that transmits a confirmation signal for confirming a connection state between the charging/discharging device 102 and the vehicle 101 to the vehicle 101. The vehicle 101 has a signal receiver 113 that receives the confirmation signal. In the second embodiment, the vehicle 101 has a storage 106 that stores change information indicating a change in the first connection state information when the signal receiver 113 receives the confirmation signal. In the second embodiment, the storage 106 is not provided in the management device 103 but is provided in the vehicle 101.

As described above, in the second embodiment, the determiner 105 is provided in the vehicle 101.

According to this configuration, it is possible to determine the connection state between the charging/discharging device 102 and the vehicle 101 after collecting and comparing both the first connection state information and the second connection state information in the vehicle 101. Therefore, it is not necessary to provide a dedicated circuit or device that detects the connection state on the vehicle 101 side and the charging/discharging device 102 side. Therefore, it is possible to suppress an increase in cost and a deterioration in convenience. For example, fitting flags can be transmitted from the EVSE (EMS) and the EV (in-vehicle telematics unit) to an upper-level server (cloud server), and both the flags can be received by the EV (in-vehicle telematics unit) from the upper-level server (cloud server). In this case, by comparing both the flags received by the EV (in-vehicle telematics unit), it is possible to provide a system capable of detecting “half-fitting” with high versatility even in equipment having no dedicated circuit or device.

### Third Embodiment

Hereinafter, a charging/discharging management system 300 according to a third embodiment will be described. In the following description, portions having the same functions as those described in the above-described embodiment will be denoted by the same names and references, and detailed description thereof will be omitted.

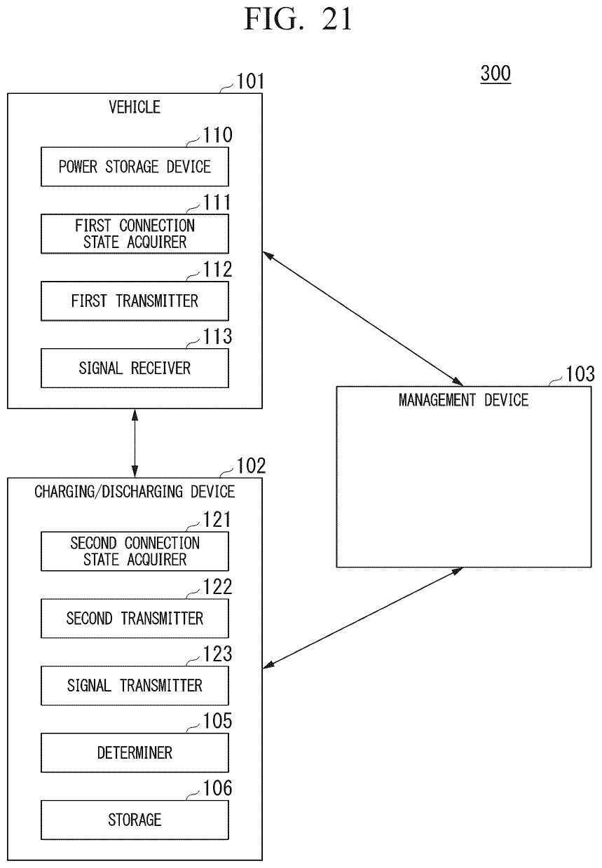

FIG. 21 is a block diagram showing a configuration of the charging/discharging management system 300 according to the third embodiment.

As shown in FIG. 21, the charging/discharging management system 300 includes a vehicle 101 including a power storage device 110, a charging/discharging device 102 that performs charging or discharging for the vehicle 101, and a management device 103 that manages charging/discharging. The vehicle 101, the charging/discharging device 102, and the management device 103 are communicable with each other through a multiplex communication line such as a CAN communication line, a serial communication line, a wireless communication network, or the like.

The vehicle 101 has a first connection state acquirer 111 that acquires first connection state information indicating a connection state between the charging/discharging device 102 and the vehicle 101, and a first transmitter 112 that transmits the first connection state information to the management device 103. The charging/discharging device 102 has a second connection state acquirer 121 that acquires second connection state information indicating a connection state between the charging/discharging device 102 and the vehicle 101, and a second transmitter 122 that transmits the second connection state information to the management device 103.

In the third embodiment, the charging/discharging device 102 has a determiner 105 that determines a connection state between the charging/discharging device 102 and the vehicle 101 on the basis of the first connection state information and the second connection state information. In the third embodiment, the determiner 105 is not provided in the management device 103 but is provided in the charging/discharging device 102.

The charging/discharging device 102 has a signal transmitter 123 that transmits a confirmation signal for confirming a connection state between the charging/discharging device 102 and the vehicle 101 to the vehicle 101. The vehicle 101 has a signal receiver 113 that receives the confirmation signal. In the third embodiment, the charging/discharging device 102 has a storage 106 that stores change information indicating a change in the first connection state information when the signal receiver 113 receives the confirmation signal. In the third embodiment, the storage 106 is not provided in the management device 103 but is provided in the charging/discharging device 102.

As described above, in the third embodiment, the determiner 105 is provided in the charging/discharging device 102.

According to this configuration, it is possible to determine the connection state between the charging/discharging device 102 and the vehicle 101 after collecting and comparing both the first connection state information and the second connection state information in the charging/discharging device 102. Therefore, it is not necessary to provide a dedicated circuit or device that detects the connection state on the vehicle 101 side and the charging/discharging device 102 side. Therefore, it is possible to suppress an increase in cost and a deterioration in convenience. For example, fitting flags can be transmitted from the EVSE (EMS) and the EV (in-vehicle telematics unit) to an upper-level server (cloud server), and both the flags can be received by the EVSE (EMS) from the upper-level server (cloud server). In this case, by comparing both the flags received by the EVSE (EMS), it is possible to provide a system capable of detecting “half-fitting” with high versatility even in equipment having no dedicated circuit or device.

### <Modifications>

In the embodiment, an example has been described in which at least one of the first connection state information and the second connection state information indicates fitting or non-fitting as the connection state between the charging/discharging device and the vehicle, but the present invention is not limited thereto. For example, as the connection state between the charging/discharging device and the vehicle, a flag indicating that the connection state is True or False may be indicated, or a continuous value (for example, 0 or 1 continues) may be indicated. In addition, the connection state is not limited to the flag, and a parameter such as a voltage value may be indicated. The forms of the first connection state information and the second connection state information can be changed according to design specifications.

In the embodiment, an example has been described in which the charging control system includes the locking mechanism that locks the charging gun and the inlet, and the unlock switch for releasing the lock, but the present invention is not limited thereto. For example, the charging control system may not include the locking mechanism. For example, the charging control system may not include the unlock switch. A configuration mode of the charging control system can be changed according to design specifications.

In the embodiment, an example has been described in which the connection portion to which the charger is connected is the inlet provided in the front portion of the electric vehicle, but the present invention is not limited thereto. For example, the connection portion to which the charger is connected may not be the inlet provided in the front portion of the electric vehicle. For example, the connection portion to which the charger is connected may be the inlet provided in a rear portion or a side portion of the electric vehicle. The form of the connection portion to which the charger is connected can be changed according to design specifications.

In the above embodiment, an example has been described in which the EVSE and the EMS constitute the charging/discharging device, but the present invention is not limited thereto. For example, the EMS may constitute the management device. The management device is not limited to functioning as a cloud server or a management server. For example, a part (for example, EMS) of the charging/discharging device may function as the management device. A configuration mode of the charging/discharging device and the management device can be changed according to design specifications.

In the embodiment, an example of the charging/discharging management system including the vehicle including the power storage device, the charging/discharging device that performs charging or discharging for the vehicle, and the management device that manages charging/discharging has been described, but the present invention is not limited thereto. For example, the present invention can also be applied to a management device that manages charging/discharging executed between a vehicle including a power storage device and a charging/discharging device that performs charging or discharging of the vehicle from an external power source. In addition, the present invention can also be applied to a vehicle including a power storage device, in which charging/discharging executed between the vehicle and a charging/discharging device that performs charging or discharging of the vehicle from an external power source is managed by a management device. Furthermore, the present invention can also be applied to a charging/discharging device that performs charging or discharging for a vehicle including a power storage device, in which charging/discharging executed between the vehicle and the charging/discharging device is managed by a management device.

Heretofore, the modes for carrying out the present invention have been described using the embodiments, but the present invention is not limited to the embodiments described above, and various modifications and substitutions can be made without departing from the gist of the present invention.

What is claimed is:

1. A charging/discharging management system comprising:
a vehicle including a power storage device;
a charging/discharging device that performs charging or discharging for the vehicle; and
a management device that manages charging/discharging,
wherein the vehicle has
a first connection state acquirer that acquires first connection state information indicating a connection state between the charging/discharging device and the vehicle, and
a first transmitter that transmits the first connection state information to the management device,
the charging/discharging device has
a second connection state acquirer that acquires second connection state information indicating a connection state between the charging/discharging device and the vehicle, and
a second transmitter that transmits the second connection state information to the management device, and
the charging/discharging management system has a determiner that determines a connection state between the charging/discharging device and the vehicle on a basis of the first connection state information and the second connection state information.

2. The charging/discharging management system according to claim 1, wherein
at least one of the first connection state information and the second connection state information indicates fitting or non-fitting as the connection state between the charging/discharging device and the vehicle.

3. The charging/discharging management system according to claim 1, wherein
when the first connection state information and the second connection state information indicate different states, the determiner determines that the connection state between the charging/discharging device and the vehicle is an invalid state.

4. The charging/discharging management system according to claim 1, wherein
the charging/discharging device has a signal transmitter that transmits a confirmation signal for confirming the connection state between the charging/discharging device and the vehicle to the vehicle,
the vehicle has a signal receiver that receives the confirmation signal,
the charging/discharging management system has a storage that stores change information indicating a change in the first connection state information when the signal receiver receives the confirmation signal, and
the determiner determines the connection state between the charging/discharging device and the vehicle on a basis of the change information.

5. The charging/discharging management system according to claim 4, wherein
the determiner determines the connection state between the charging/discharging device and the vehicle on a basis of a fact that the number of times the first connection state information changes is more than a predetermined number in a predetermined period.

6. The charging/discharging management system according to claim 4, wherein
the determiner determines the connection state between the charging/discharging device and the vehicle on a basis of a charging/discharging instruction value received by the charging/discharging device in a predetermined period.

7. The charging/discharging management system according to claim 6, wherein
the determiner determines the connection state between the charging/discharging device and the vehicle on a basis of whether the charging/discharging instruction value is 0 in the predetermined period.

8. The charging/discharging management system according to claim 4, wherein
the signal transmitter transmits the confirmation signal to the vehicle at a predetermined interval, and
the determiner determines the connection state between the charging/discharging device and the vehicle on a basis of the predetermined interval and an interval of the change information.

9. The charging/discharging management system according to claim 1, wherein
the charging/discharging device has a signal transmitter that transmits a confirmation signal for confirming the connection state between the charging/discharging device and the vehicle to the vehicle,
the vehicle has a signal receiver that receives the confirmation signal,
the charging/discharging management system has a storage that stores change information indicating a change in other state information different from the first connection state information when the signal receiver receives the confirmation signal, and
the determiner determines the connection state between the charging/discharging device and the vehicle on a basis of the change information.

10. The charging/discharging management system according to claim 9, wherein
the determiner determines the connection state between the charging/discharging device and the vehicle on a basis of a fact that the number of times the other state information changes is more than a predetermined number in a predetermined period.

11. The charging/discharging management system according to claim 9, wherein
the determiner determines the connection state between the charging/discharging device and the vehicle on a basis of a charging/discharging instruction value received by the charging/discharging device in a predetermined period.

12. The charging/discharging management system according to claim 11, wherein
the determiner determines the connection state between the charging/discharging device and the vehicle on a basis of whether the charging/discharging instruction value is 0 in the predetermined period.

13. The charging/discharging management system according to claim 9, wherein
the signal transmitter transmits the confirmation signal to the vehicle at a predetermined interval, and
the determiner determines the connection state between the charging/discharging device and the vehicle on a basis of the predetermined interval and an interval of the change information.

14. A charging/discharging management system comprising:
a vehicle including a power storage device;
a charging/discharging device that performs charging or discharging for the vehicle; and
a management device that manages charging/discharging,
wherein the vehicle has
a first connection state acquirer that acquires first connection state information indicating a connection state between the charging/discharging device and the vehicle, and
a first transmitter that transmits the first connection state information to the management device,
the charging/discharging device has
a second connection state acquirer that acquires second connection state information indicating a connection state between the charging/discharging device and the vehicle, and
a second transmitter that transmits the second connection state information to the management device, and
the charging/discharging management system has a determiner that determines a connection state between the charging/discharging device and the vehicle on a basis of other state information different from the first connection state information.

15. A management device that manages charging/discharging executed between a vehicle including a power storage device and a charging/discharging device that performs charging or discharging of the vehicle from an external power source,
wherein the management device has a determiner that determines a connection state between the charging/discharging device and the vehicle on a basis of first connection state information that is transmitted from a first transmitter of the vehicle and indicates a connection state between the charging/discharging device and the vehicle, and second connection state information that is transmitted from a second transmitter of the charging/discharging device and indicates a connection state between the charging/discharging device and the vehicle.

16. The management device according to claim 15, wherein
at least one of the first connection state information and the second connection state information indicates fitting or non-fitting as the connection state between the charging/discharging device and the vehicle.

17. The management device according to claim 15, wherein
when the first connection state information and the second connection state information indicate different states, the determiner determines that the connection state between the charging/discharging device and the vehicle is an invalid state.

18. The management device according to claim 15, wherein
the charging/discharging device has a signal transmitter that transmits a confirmation signal for confirming the connection state between the charging/discharging device and the vehicle to the vehicle,
the vehicle has a signal receiver that receives the confirmation signal,
the management device has a storage that stores change information indicating a change in the first connection state information when the signal receiver receives the confirmation signal, and
the determiner determines the connection state between the charging/discharging device and the vehicle on a basis of the change information.

19. The management device according to claim 18, wherein
the determiner determines the connection state between the charging/discharging device and the vehicle on a basis of a fact that the number of times the first connection state information changes is more than a predetermined number in a predetermined period.

20. The management device according to claim 18, wherein
the determiner determines the connection state between the charging/discharging device and the vehicle on a basis of a charging/discharging instruction value received by the charging/discharging device in a predetermined period.

21. The management device according to claim 20, wherein
the determiner determines the connection state between the charging/discharging device and the vehicle on a basis of whether the charging/discharging instruction value is 0 in the predetermined period.

22. The management device according to claim 18, wherein
the signal transmitter transmits the confirmation signal to the vehicle at a predetermined interval, and
the determiner determines the connection state between the charging/discharging device and the vehicle on a basis of the predetermined interval and an interval of the change information.

23. The management device according to claim 15, wherein
the charging/discharging device has a signal transmitter that transmits a confirmation signal for confirming the connection state between the charging/discharging device and the vehicle to the vehicle,
the vehicle has a signal receiver that receives the confirmation signal,
the management device has a storage that stores change information indicating a change in other state information different from the first connection state information when the signal receiver receives the confirmation signal, and
the determiner determines the connection state between the charging/discharging device and the vehicle on a basis of the change information.

24. The management device according to claim 23, wherein
the determiner determines the connection state between the charging/discharging device and the vehicle on a basis of a fact that the number of times the other state information changes is more than a predetermined number in a predetermined period.

25. The management device according to claim 23, wherein
the determiner determines the connection state between the charging/discharging device and the vehicle on a basis of a charging/discharging instruction value received by the charging/discharging device in a predetermined period.

26. The management device according to claim 25, wherein
the determiner determines the connection state between the charging/discharging device and the vehicle on a basis of whether the charging/discharging instruction value is 0 in the predetermined period.

27. The management device according to claim 23, wherein
the signal transmitter transmits the confirmation signal to the vehicle at a predetermined interval, and
the determiner determines the connection state between the charging/discharging device and the vehicle on a basis of the predetermined interval and an interval of the change information.

28. A vehicle comprising a power storage device,
wherein charging/discharging executed between the vehicle and a charging/discharging device that performs charging or discharging of the vehicle from an external power source is managed by a management device,
the vehicle has
a first connection state acquirer that acquires first connection state information indicating a connection state between the charging/discharging device and the vehicle, and
a first transmitter that transmits the first connection state information to the management device,
the charging/discharging device has
a second connection state acquirer that acquires second connection state information indicating a connection state between the charging/discharging device and the vehicle, and
a second transmitter that transmits the second connection state information to the management device, and
the vehicle has a determiner that determines a connection state between the charging/discharging device and the vehicle on a basis of the first connection state information and the second connection state information.

29. The vehicle according to claim 28, wherein
at least one of the first connection state information and the second connection state information indicates fitting or non-fitting as the connection state between the charging/discharging device and the vehicle.

30. The vehicle according to claim 28, wherein
when the first connection state information and the second connection state information indicate different states, the determiner determines that the connection state between the charging/discharging device and the vehicle is an invalid state.

31. The vehicle according to claim 28, wherein
the charging/discharging device has a signal transmitter that transmits a confirmation signal for confirming the connection state between the charging/discharging device and the vehicle to the vehicle,
the vehicle has a signal receiver that receives the confirmation signal,
the vehicle has a storage that stores change information indicating a change in the first connection state information when the signal receiver receives the confirmation signal, and
the determiner determines the connection state between the charging/discharging device and the vehicle on a basis of the change information.

32. The vehicle according to claim 31, wherein
the determiner determines the connection state between the charging/discharging device and the vehicle on a basis of a fact that the number of times the first connection state information changes is more than a predetermined number in a predetermined period.

33. The vehicle according to claim 31, wherein
the determiner determines the connection state between the charging/discharging device and the vehicle on a basis of a charging/discharging instruction value received by the charging/discharging device in a predetermined period.

34. The vehicle according to claim 33, wherein
the determiner determines the connection state between the charging/discharging device and the vehicle on a basis of whether the charging/discharging instruction value is 0 in the predetermined period.

35. The vehicle according to claim 31, wherein
the signal transmitter transmits the confirmation signal to the vehicle at a predetermined interval, and
the determiner determines the connection state between the charging/discharging device and the vehicle on a basis of the predetermined interval and an interval of the change information.

36. The vehicle according to claim 28, wherein
the charging/discharging device has a signal transmitter that transmits a confirmation signal for confirming the connection state between the charging/discharging device and the vehicle to the vehicle,
the vehicle has a signal receiver that receives the confirmation signal,
the vehicle has a storage that stores change information indicating a change in other state information different from the first connection state information when the signal receiver receives the confirmation signal, and
the determiner determines the connection state between the charging/discharging device and the vehicle on a basis of the change information.

37. The vehicle according to claim 36, wherein
the determiner determines the connection state between the charging/discharging device and the vehicle on a basis of a fact that the number of times the other state information changes is more than a predetermined number in a predetermined period.

38. The vehicle according to claim 36, wherein
the determiner determines the connection state between the charging/discharging device and the vehicle on a basis of a charging/discharging instruction value received by the charging/discharging device in a predetermined period.

39. The vehicle according to claim 38, wherein
the determiner determines the connection state between the charging/discharging device and the vehicle on a basis of whether the charging/discharging instruction value is 0 in the predetermined period.

40. The vehicle according to claim 36, wherein
the signal transmitter transmits the confirmation signal to the vehicle at a predetermined interval, and
the determiner determines the connection state between the charging/discharging device and the vehicle on a basis of the predetermined interval and an interval of the change information.

41. A charging/discharging device that performs charging or discharging for a vehicle including a power storage device,
wherein charging/discharging executed between the vehicle and the charging/discharging device is managed by a management device,
the vehicle has
a first connection state acquirer that acquires first connection state information indicating a connection state between the charging/discharging device and the vehicle, and
a first transmitter that transmits the first connection state information to the management device,
the charging/discharging device has
a second connection state acquirer that acquires second connection state information indicating a connection state between the charging/discharging device and the vehicle, and
a second transmitter that transmits the second connection state information to the management device, and
the charging/discharging device has a determiner that determines a connection state between the charging/discharging device and the vehicle on a basis of the first connection state information and the second connection state information.

42. The charging/discharging device according to claim 41, wherein
at least one of the first connection state information and the second connection state information indicates fitting or non-fitting as the connection state between the charging/discharging device and the vehicle.

43. The charging/discharging device according to claim 41, wherein
when the first connection state information and the second connection state information indicate different states, the determiner determines that the connection state between the charging/discharging device and the vehicle is an invalid state.

44. The charging/discharging device according to claim 41, wherein
the charging/discharging device has a signal transmitter that transmits a confirmation signal for confirming the connection state between the charging/discharging device and the vehicle to the vehicle,
the vehicle has a signal receiver that receives the confirmation signal,
the charging/discharging device has a storage that stores change information indicating a change in the first connection state information when the signal receiver receives the confirmation signal, and
the determiner determines the connection state between the charging/discharging device and the vehicle on a basis of the change information.

45. The charging/discharging device according to claim 44, wherein
the determiner determines the connection state between the charging/discharging device and the vehicle on a basis of a fact that the number of times the first connection state information changes is more than a predetermined number in a predetermined period.

46. The charging/discharging device according to claim 44, wherein
the determiner determines the connection state between the charging/discharging device and the vehicle on a basis of a charging/discharging instruction value received by the charging/discharging device in a predetermined period.

47. The charging/discharging device according to claim 46, wherein
the determiner determines the connection state between the charging/discharging device and the vehicle on a basis of whether the charging/discharging instruction value is 0 in the predetermined period.

48. The charging/discharging device according to claim 44, wherein
the signal transmitter transmits the confirmation signal to the vehicle at a predetermined interval, and
the determiner determines the connection state between the charging/discharging device and the vehicle on a basis of the predetermined interval and an interval of the change information.

49. The charging/discharging device according to claim 41, wherein
the charging/discharging device has a signal transmitter that transmits a confirmation signal for confirming the connection state between the charging/discharging device and the vehicle to the vehicle,
the vehicle has a signal receiver that receives the confirmation signal,
the charging/discharging device has a storage that stores change information indicating a change in other state information different from the first connection state information when the signal receiver receives the confirmation signal, and
the determiner determines the connection state between the charging/discharging device and the vehicle on a basis of the change information.

50. The charging/discharging device according to claim 49, wherein
the determiner determines the connection state between the charging/discharging device and the vehicle on a basis of a fact that the number of times the other state information changes is more than a predetermined number in a predetermined period.

51. The charging/discharging device according to claim 49, wherein
the determiner determines the connection state between the charging/discharging device and the vehicle on a basis of a charging/discharging instruction value received by the charging/discharging device in a predetermined period.

52. The charging/discharging device according to claim 51, wherein
the determiner determines the connection state between the charging/discharging device and the vehicle on a basis of whether the charging/discharging instruction value is 0 in the predetermined period.

53. The charging/discharging device according to claim 49, wherein
the signal transmitter transmits the confirmation signal to the vehicle at a predetermined interval, and
the determiner determines the connection state between the charging/discharging device and the vehicle on a basis of the predetermined interval and an interval of the change information.
